(19) United States
(12) Patent Application Publication
(10) Pub. No.: US 2024/0209184 A1
(43) Pub. Date: Jun. 27, 2024

(54) ALIPHATIC COPOLYAMIDE COMPOSITION

(71) Applicant: BASF SE, Ludwigshafen am Rhein (DE)

(72) Inventors: Patrick SPIES, Ludwigshafen (DE); Mohammad MEYSAMI, Budd Lake, NJ (US)

(21) Appl. No.: 18/553,620

(22) PCT Filed: Apr. 28, 2022
(86) PCT No.: PCT/EP22/61351

§ 371 Date: Oct. 2, 2023

(30) Foreign Application Priority Data
Apr. 30, 2021 (EP) 21171563.6

(51) Int. Cl. C08K 5/36; B05D 7/00; C08G 69/14; C08G 69/26; C08K 5/29; C09D 177/02; C09D 177/06

(52) U.S. Cl. CPC C08K 5/36; B05D 7/532; C08G 69/14; C08G 69/26; C08K 5/29; C09D 177/02; C09D 177/06; B05D 2505/00; C08G 2150/00; C08G 2170/00; C08G 2190/00

(57) ABSTRACT

Disclosed herein is a polymer blend including a) from >50 wt. % to 99 wt. % of at least one aliphatic copolyamide as component A); and b) from 1 wt. % to <50 wt. % of at least one semicrystalline, semiaromatic or aromatic polyamide as component B), where the total of wt. % of components A) and B) is 100 wt. %. Further disclosed herein is a thermoplastic molding composition including said polymer blend and at least one additional substance C), processes for preparing said polymer blend and said thermoplastic molding composition, a method of using said polymer blend and said thermoplastic molding composition for the production of molded and extruded parts, and molded and extruded parts produced from said polymer blend or said thermoplastic molding composition.

The present invention relates to a polymer blend comprising at least one aliphatic copolyamide and at least one semicrystalline, semiaromatic or aromatic polyamide, a thermoplastic molding composition comprising said polymer blend and at least one additional substance, and the use of the polymer blend or the thermoplastic molding composition for the production of molded and extruded parts.

The aliphatic copolyamide PA 6/6.36 can be derived via copoylmerization of Caprolactame, HMD and an alipahtic C36-dicarboxyl acid. PA 6/6.36 is partially based on renewable sources, has a decreased humidity absorption compared to standard polyamides like PA6 or PA66 and shows a good resistance besides aqueous media like salt solutions. PA 6/6.36 is used for foil and sheet extrusion. However, the aliphatic copolyamide seems to be sticky which can lead to problems during the injection molding and pipe extrusion process. Further, the aliphatic copolyamide seems to lose stiffness during conditioning in standard atmosphere.

The object underlying the present invention is to provide polyamide compositions having the beneficial properties of aliphatic copolyamides, especially of copolyamide PA 6/6.36, but a superior performance profile, for example a higher stiffness in the conditioned state, which compositions are especially suitable for molding processes like injection molding and pipe extrusion.

By providing a polymer blend comprising an aliphatic copolyamide and a semicrystalline, semiaromatic or aromatic polyamide, polyamide compounds are obtained having a superior performance profile and which are highly suitable for injection molding and pipe extrusion processes, compared with polyamide compounds based on polymer blends comprising a semiaromatic or aromatic polyamide which is not semicrystalline and an aliphatic copolyamide.

Blends of aliphatic polyamides and aromatic polyamides are known.

Xanthos et al., Journal of Applied Polymer Science, Vol. 62, 1167-1177 (1996) describes blends of polyamide 6 (N6) and amorphous aromatic polyamide PA61/6T (Zytel-330 (2-330)) (AmArPA).

Blends of varying compositions were extrusion compounded with an impact modifying reactive elastomer and injection molded. The relationship between blend morphology, blend components structure and reactivity, and processing conditions with ultimate properties is discussed.

Huang et al., Polymer 47 (2006) 624-638 studies the distribution of impact modifiers in blends of polyamide 6 (nylon 6) and amorphous aromatic polyamide PA61/6T (Zytel 330) (AmArPA).

WO2007/041723 A1 describes copolyamide composition for marine umbilical consisting of aromatic dicarboxylic acids, diamines and aliphatic dicarboxylic acids obtained by copolymerization. A preferred copolyamide comprises repeat units (a) that are derived from terephthalic acid and hexamethylenediamine and repeat units (b) that are derived from decanedioic acid and/or dodecanedioic acid and hexamethylenediamine.

WO 2019/057849 A1 relates to a heat-resistant polyamide composition including a copolyamide and an anhydride-functional polymer. The copolyamide includes the reaction product of at least one lactam and a monomer mixture. The monomer mixture includes at least one C₃₂ -C₄₀-dimer acid, and at least one C₄ -C₁₂-diamine.

US 2015/344686 relates to a prepreg that can give a fiber-reinforced composite material exhibiting stable and excellent interlaminar fracture toughness and impact resistance under wide molding conditions.

WO 2021/003047 A1 relates to a pregreg that can be cured/molded to form aerospace composite parts.

None of WO 2019/057849 A1, US 2015/344686 and WO 2021/003047 A1 disclose a blend comprising beside more than 50 wt. % of at least one aliphatic copolyamide at least 1 wt. % of at least one semi-crystalline polyamide which is at the same time semi-aromatic or aromatic.

However, the polymer blends of aliphatic polyamides and amorphous aromatic polyamides disclosed in the prior art do not achieve the object mentioned above in a sufficient manner.

The object is achieved according to the present invention by a polymer blend comprising
a) from >50 wt. % to 99 wt. % of at least one aliphatic copolyamide as component A);
b) from 1 wt. % to <50 wt. % of at least one semicrystalline, semiaromatic or aromatic polyamide as component B;
   wherein the total of wt. % of components A and B is 100 wt. %.

The invention also relates to a thermoplastic molding composition comprising the polymer blend and at least one additional substance C.

The invention also relates to a process for preparing the polymer blend by mixing components A and B.

The invention also relates to the use of these polymer blends or these thermoplastic molding compositions for producing moldings, sheets, foils, tubes and pipes of any type.

The invention furthermore relates to a molding, a sheet, a foil a tube or a pipes, made of these polymer blends or these thermoplastic molding compositions.

According to the present invention, it has been found that a combination of an aliphatic copolyamide and a semicrystalline, semiaromatic or aromatic polyamide, achieves the above mentioned object.

The inventive blends and the inventive thermoplastic molding compositions are especially characterized by one or more of the following properties: High stability against zinc chloride and add blue, high heat deflection temperature, high tensile modulus in the dry and the conditioned state, high stiffness in the conditioned state, low water uptake, high barrier against fuels. The inventive blends show improved processing properties in pipe and sheet extrusion and injection molding processes. Via the blend approach the material can be easily demolded from the injection moding maschine and shows nearly no tendency for sticking to the nozzle compared to pure aliphatic copolyamides.

The inventive blends and the inventive thermoplastic molding compositions are useful in a wide range of applications, especially in the field of engineering plastics, especially in the automotive industry, which are in contact with fluids like cooling fluid, brake and clutch fluid, chemicals (add blue), fuels and or salt, e.g extruded tubes (e.g. fluid pipes for fuel or cooling fluid in cars), mandrels and injection molded articles like functional parts for engines sensor (e.g. wheel speed sensor), pumps, connectors, or injected or extruded parts of fuels cells.

### Blends

The amount of component A) in the inventive blends is >50 to 99% by weight, preferably 55 to 97% by weight, more preferably 60 to 95% by weight.

The amount of component B) in the inventive blends is 1 to <50% by weight, preferably 3 to 45% by weight, more preferably 5 to 40% by weight.

The total of wt. % of components A and B is 100 wt. %.

Preferably, component A) forms the continuous phase.

The weight ratio of component A) to component B) is preferably 1.1:1 to 15:1, more preferably 1.3:1 to 12:1, most preferably 1.5:1 to 10:1, specifically 1.7:1 to 9:1.

### Component B)

Component B) is at least one semicrystalline, semiaromatic or aromatic polyamide. Suitable semicrystalline, semiaromatic or aromatic polyamides are known in the art. Preferably, the at least one semicrystalline polyamide of component B is semiaromatic and/or a copolyamide, more preferably, the at least one the at least one polyamide of component B is a semicrystalline, semiaromatic copolyamide. Suitable semicrystalline, semiaromatic copolyamides are for example disclosed in EP 0 299 222 A, EP 0 667 367 A and US 2012/0245283.

Generally, the semicrystalline, semiaromatic copolyamides are copolymers made from the condensation of aliphatic amides, such as caprolactam and/or hexamethylene diamine, with aromatic dicarboxylic acids or acid derivatives, such as terephthalic acid and/or isophthalic acid, i.e. these polyamides are partially aromatic polyamides.

More preferably, component B) is at least one semicrystalline, semiaromatic polyamide containing repeating units of hexamethylenediamine and terephthalic acid. Preferably, component B) contains 45 to 95% by weight, more preferably 60 to 80% by weight, most preferably 65 to 75% by weight of repeating units of hexamethylenediamine and terephthalic acid. The remainder can be aliphatic polyamide repeating units, like caprolactam or hexamethylene adipamide, or semiaromatic repeating units, like polyamide-6I.

Preferably, component B) has a viscosity number VZ of 60 to 200 ml/g, more preferably 70 to 140 ml/g.

In a further preferred embodiment, the at least one polyamide of component B has a melting point of >250° C. Most preferably, the at least one thermoplastic semiaromatic semicrystalline polyamide B) is selected from polyamide-6T/6, polyamide-6T/66, polyamide-6T/6I and mixtures thereof.

### Component A)

Component A) is at least one aliphatic copolyamide. Suitable aliphatic copolyamides are known in the art.

Preferably, the aliphatic copolyamide of component A has a melting point of <220° C.

More preferably, the at least one copolyamide of component A) is produced by polymerization of the following components
A′) 15 wt. % to 84 wt. % of at least one lactam,
B′) 16 wt. % to 85 wt. % of a monomer mixture (M) comprising the components
   B1′) at least one C₃₂-C₄₀-dimer acid and
   B2′) at least one C₄-C₁₂ diamine,
      wherein the percentages by weight of the components A′) and B′) are in each case based on the sum of the percentages by weight of the components A′) and B′).

In the context of the present invention the terms “component A′)” and “at least one lactam” are used synonymously and therefore have the same meaning.

The same applies for the terms “component B′)” and “monomer mixture (M)”. These terms are likewise used synonymously in the context of the present invention and therefore have the same meaning.

According to the invention the at least one copolyamide is produced by polymerization of 15 to 84 wt % of the component A′) and 16 to 85 wt % of the component B′), preferably by polymerization of 40 to 83 wt % of the component A′) and 17 to 60 wt % of the component B′) and especially preferably by polymerization of 60 to 80 wt % of the component A′) and 20 to 40 wt % of the component B′), wherein the percentages by weight of the components A′) and B′) are in each based on the sum of the percentages by weight of the components A′) and B′).

The sum of the percentages by weight of the components A′) and B′) is preferably 100 wt %.

It will be appreciated that the weight percentages of the components A′) and B′) relate to the weight percentages of the components A′) and B′) prior to the polymerization, i.e. when the components A′) and B′) have not yet reacted with one another. During the polymerization of the components A′) and B′) the weight ratio of the components A′) and B′) may optionally change.

The at least one copolyamide of component A) is produced by polymerization of the components A′) and B′). The polymerization of the components A′) and B′) is known to those skilled in the art. The polymerization of the components A′) with B′) is typically a condensation reaction. During the condensation reaction the component A′) reacts with the components B1′) and B2′) present in the component B′) and optionally with the component B3′) described hereinbelow which may likewise be present in the component B′). This causes amide bonds to form between the individual components. During the polymerization the component A′) is typically at least partially in open chain form, i.e. in the form of an amino acid.

The polymerization of the components A′) and B′) may take place in the presence of a catalyst. Suitable catalysts include all catalysts known to those skilled in the art which catalyze the polymerization of the components A′) and B′). Such catalysts are known to those skilled in the art. Preferred catalysts are phosphorus compounds, for example sodium hypophosphite, phosphorous acid, triphenylphosphine or triphenyl phosphite.

The polymerization of the components A′) and B′) forms the at least one copolyamide which therefore comprises units derived from the component A′) and units derived from the component B′). Units derived from the component B′) comprise units derived from the components B1′) and B2′) and optionally from the component B3′).

The polymerization of the components A′) and B′) forms the copolyamide as a copolymer. The copolymer may be a random copolymer. It may likewise be a block copolymer.

Formed in a block copolymer are blocks of units derived from the component B′) and blocks of units derived from the component A′). These appear in alternating sequence. In a random copolymer units derived from the component A′) alternate with units derived from the component B′). This alternation is random. For example two units derived from the component B′) may be followed by one unit derived from the component A′) which is followed in turn by a unit derived from the component B′) and then by a unit comprising three units derived from the component A′).

Production of the at least one copolyamide preferably comprises steps of:
I) polymerizing the components A′) and B′) to obtain at least a first copolyamide,
II) pelletizing the at least one first copolyamide obtained in step I) to obtain at least one pelletized copolyamide,
III) extracting the at least one pelletized copolyamide obtained in step II) with water to obtain at least one extracted copolyamide,
IV) drying the at least one extracted copolyamide obtained in step III) at a temperature (TT) to obtain the at least one copolyamide,
IV) drying the at least one extracted copolyamide obtained in step III) at a temperature (TT) to obtain the at least one copolyamide.

The polymerization in step I) may be carried out in any reactor known to those skilled in the art. Preference is given to stirred tank reactors. It is also possible to use auxiliaries known to those skilled in the art, for example defoamers such as polydimethylsiloxane (PDMS), to improve reaction management.

In step II) the at least one first copolyamide obtained in step I) may be pelletized by any methods known to those skilled in the art, for example by strand pelletization or underwater pelletization.

The extraction in step III) may be effected by any methods known to those skilled in the art.

During the extraction in step III) byproducts typically formed during the polymerization of the components A′) and B′) in step I) are extracted from the at least one pelletized copolyamide.

In step IV) the at least one extracted copolyamide obtained in step III) is dried. Processes for drying are known to those skilled in the art. According to the invention the at least one extracted copolyamide is dried at a temperature (T_{T}). The temperature (T_{T}) is preferably above the glass transition temperature (T_{G(C)}) of the at least one copolyamide and below the melting temperature (T_{M(C)}) of the at least one copolyamide.

The drying in step IV) is typically carried out for a period in the range from 1 to 100 hours, preferably in the range from 2 to 50 hours and especially preferably in the range from 3 to 40 hours.

It is thought that the drying in step IV) further increases the molecular weight of the at least one copolyamide.

The at least one copolyamide of component A)—without addition of component B)—typically has a glass transition temperature (T_{G(C)}). The glass transition temperature (T_{G(C)}) is for example in the range from 20° C. to 50° C., preferably in the range from 23° C. to 50° C. and especially preferably in the range from 25° C. to 50° C. determined according to ISO 11357-2:2014.

In the context of the present invention the glass transition temperature (T_{G(C)})) of the at least one copolyamide is based, in accordance with ISO 11357-2:2014, on the glass transition temperature (T_{G(C)})) of the dry copolyamide.

In the context of the present invention “dry” is to be understood as meaning that the at least one copolyamide comprises less than 1 wt %, preferably less than 0.5 wt %, and especially preferably less than 0.1 wt % of water based on the total weight of the at least one copolyamide. “Dry” is more preferably to be understood as meaning that the at least one copolyamide comprises no water and most preferably that the at least one copolyamide comprises no solvent.

In addition, the at least one copolyamide typically has a melting temperature (T_{M(C)}). The melting temperature (T_{M(C)}) of the at least one copolyamide is, for example, in the range from 150 to 210° C., preferably in the range from 160 to 205° C. and especially preferably in the range from 160 to 200° C. determined according to ISO 11357-3:2014.

The at least one copolyamide generally has a viscosity number (VN_{(C)}) in the range from 150 to 300 ml/g determined in a 0.5% by weight solution of the at least one copolyamide in a mixture of phenol/o-dichlorobenzene in a weight ratio of 1:1.

It is preferable when the viscosity number (VN_{(C)}) of the at least one copolyamide is in the range from 160 to 290 mL/g and particularly preferably in the range from 170 to 280 mL/g determined in a 0.5% by weight solution of the at least one copolyamide in a mixture of phenol/o-dichlorobenzene in a weight ratio of 1:1.

### Component A′)

According to the invention the component A′) is at least one lactam.

In the context of the present invention “at least one lactam” is understood as meaning either precisely one lactam or a mixture of 2 or more lactams.

Lactams are known per se to those skilled in the art. Preferred according to the invention are lactams having 4 to 12 carbon atoms.

In the context of the present invention “lactams” are to be understood as meaning cyclic amides having preferably 4 to 12 carbon atoms, particularly preferably 5 to 8 carbon atoms, in the ring.

Suitable lactams are for example selected from the group consisting of 3-aminopropanolactam (propio-3-lactam; β-lactam; β-propiolactam), 4-aminobutanolactam (butyro-4-lactam; γ-lactam; γ-butyrolactam), aminopentanolactam (2-piperidinone; δ-lactam; δ-valerolactam), 6-aminohexanolactam (hexano-6-lactam; ε-lactam; ε-caprolactam), 7-aminoheptanolactam (heptano-7-lactam; ζ-lactam; ζ-heptanolactam), 8-aminooctanolactam (octano-8-lactam; η-lactam; η-octanolactam), 9-aminononanolactam (nonano-9-lactam; θ-lactam; θ-nonanolactam), 10-aminodecanolactam (decano-10-lactam; ω-decanolactam), 11-aminoundecanolactam (undecano-11-lactam; ω-undecanolactam) and 12-aminododecanolactam (dodecano-12-lactam; ω-dodecanolactam).

The present invention therefore also provides a process where the component A′) is selected from the group consisting of 3-aminopropanolactam, 4-aminobutanolactam, 5-aminopentanolactam, 6-aminohexanolactam, 7-aminoheptanolactam, 8-aminooctanolactam, 9-aminononanolactam, 10-aminodecanolactam, 11-aminoundecanolactam and 12-aminododecanolactam.

The lactams may be unsubstituted or at least monosubstituted. If at least monosubstituted lactams are used, the nitrogen atom and/or the ring carbon atoms thereof may bear one, two, or more substituents selected independently of one another from the group consisting of C₁ to C₁₀ alkyl, C₅ to C₆ cycloalkyl, and C₅ to C₁₀ aryl.

Suitable C₁- to C₁₀-alkyl substituents are, for example, methyl, ethyl, propyl, isopropyl, n-butyl, sec-butyl, and tert-butyl. A suitable C₅- to C₆-cycloalkyl substituent is for example cyclohexyl. Preferred C₅- to C₁₀-aryl substituents are phenyl or anthranyl.

It is preferable to employ unsubstituted lactams, γ-lactam (γ-butyrolactam), δ-lactam (δ-valerolactam) and ε-lactam (ε-caprolactam) being preferred. Particular preference is given to δ-lactam (δ-valerolactam) and ε-lactam (ε-caprolactam), ε-caprolactam being especially preferred.

### Monomer Mixture (M)

According to the invention the component B′) is a monomer mixture (M). The monomer mixture (M) comprises the components B1′), at least one C₃₂-C₄₀ dimer acid, and B2′), at least one C₄-C₁₂ diamine.

In the context of the present invention a monomer mixture (M) is to be understood as meaning a mixture of two or more monomers, wherein at least components B1′) and B2′) are present in the monomer mixture (M).

In the context of the present invention the terms “component B1′)” and “at least one C₃₂-C₄₀ dimer acid” are used synonymously and therefore have the same meaning. The same applies for the terms “component B2′)” and “at least one C₄-C₁₂ diamine”. These terms are likewise used synonymously in the context of the present invention and therefore have the same meaning.

The monomer mixture (M) comprises, for example, in the range from 45 to 55 mol % of the component B1′) and in the range from 45 to 55 mol % of the component B2′) in each case based on the sum of the mole percentages of the components B1′) and B2′), preferably based on the total amount of substance of the monomer mixture (M).

It is preferable when the component B′) comprises in the range from 47 to 53 mol % of component B1′) and in the range from 47 to 53 mol % of component B2′) in each case based on the sum of the mole percentages of the components B1′) and B2′), preferably based on the total amount of substance of the component B′).

It is particularly preferable when the component B′) comprises in the range from 49 to 51 mol % of the component B1′) and in the range from 49 to 51 mol % of the component B2′) in each case based on the sum total of the mole percentages of the components B1′) and B2′), preferably based on the total amount of substance of the component B′).

The mole percentages of the components B1′) and B2′) present in the component B′) typically sum to 100 mol %.

The component B′) may additionally comprise a component B3′), at least one C₄-C₂₀ diacid.

In the context of the present invention, the terms “component B3′)” and “at least one C₄-C₂₀ diacid” are used synonymously and therefore have the same meaning.

When the component B′) additionally comprises the component B3′) it is preferable when component B′) comprises in the range from 25 to 54.9 mol % of the component B1′), in the range from 45 to 55 mol % of the component B2′) and in the range from 0.1 to 25 mol % of the component B3′) in each case based on the total amount of substance of the component B′).

It is particularly preferable when the component B′) then comprises in the range from 13 to 52.9 mol % of the component B1′), in the range from 47 to 53 mol % of the component B2′) and in the range from 0.1 to 13 mol % of the component B3′) in each case based on the total amount of substance of the component B′).

It is most preferable when the component B′) then comprises in the range from 7 to 50.9 mol % of the component B1′), in the range from 49 to 51 mol % of the component B2′) and in the range from 0.1 to 7 mol % of the component B3′) in each case based on the total amount of substance of the component B′).

When component B′) additionally comprises the component B3′) the mole percentages of the components B1′), B2′) and B3′) typically sum to 100 mol %.

The monomer mixture (M) may further comprise water.

The components B1′) and B2′) and optionally B3′) of the component B′) can react with one another to obtain amides. This reaction is known per se to those skilled in the art. The component B′) may therefore comprise components B1′), B2′) and optionally B3′) in fully reacted form, in partially reacted form or in unreacted form. It is preferable when the component B′) comprises the components B1′), B2′) and optionally B3′) in unreacted form.

In the context of the present invention “in unreacted form” is thus to be understood as meaning that the component B1′) is present as the at least one C₃₂-C₄₀ dimer acid and the component B2′) is present as the at least one C₄-C₁₂-diamine and optionally the component B3′) is present as the at least one C₄-C₂₀ diacid.

If the components B1′) and B2′) and optionally B3′) have at least partly reacted the components B1′) and B2′) and any B3′) are thus at least partially in amide form.

### Component B1′)

According to the invention the component B1′) is at least one C₃₂-C₄₀ dimer acid.

In the context of the present invention “at least one C₃₂-C₄₀ dimer acid” is to be understood as meaning either precisely one C₃₂-C₄₀-dimer acid or a mixture of two or more C₃₂-C₄₀ dimer acids.

Dimer acids are also referred to as dimer fatty acids. C₃₂-C₄₀ dimer acids are known per se to those skilled in the art and are typically produced by dimerization of unsaturated fatty acids. This dimerization may be catalyzed by argillaceous earths for example.

Suitable unsaturated fatty acids for producing the at least one C₃₂-C₄₀ dimer acid are known to those skilled in the art and are for example unsaturated C₁₆-fatty acids, unsaturated C₁₈ fatty acids and unsaturated C₂₀ fatty acids.

It is therefore preferable when the component B1′) is produced from unsaturated fatty acids selected from the group consisting of unsaturated C₁₆ fatty acids, unsaturated C₁₈ fatty acids and unsaturated C₂₀ fatty acids, wherein the unsaturated C₁₈ fatty acids are particularly preferred.

A suitable unsaturated C₁₆ fatty acid is palmitoleic acid ((9Z)-hexadeca-9-enoic acid) for example.

Suitable unsaturated C₁₈ fatty acids are for example selected from the group consisting of petroselic acid ((6Z)-octadeca-6-enoic acid), oleic acid ((9Z)-octadeca-9-enoic acid), elaidic acid ((9E)-octadeca-9-enoic acid), vaccenic acid ((11E)-octadeca-11-enoic acid), linoleic acid ((9Z,12Z)-octadeca-9,12-dienoic acid), α-linolenic acid ((9Z,12Z,15Z)-octadeca-9,12,15-trienoic acid), γ-linolenic acid ((6Z,9Z,12Z)-octadeca-6,9,12-trienoic acid), calendulic acid ((8E,10E, 12Z)-octadeca-8,10,12-trienoic acid), punicic acid ((9Z,11E,13Z)-octadeca-9,11,13-trienoic acid), α-eleostearic acid ((9Z,11E,13E)-octadeca-9,11,13-trienoic acid) and β-eleostearic acid ((9E,11E,13E)-octadeca-9,11,13-trienoic acid). Particular preference is given to unsaturated C₁₈ fatty acids selected from the group consisting of petroselic acid ((6Z)-octadeca-6-enoic acid), oleic acid ((9Z)-octadeca-9-enoic acid), elaidic acid ((9E)-octadeca-9-enoic acid), vaccenic acid ((11E)-octadeca-11-enoic acid), linoleic acid ((9Z,12Z)-octadeca-9,12-dienoic acid).

Suitable unsaturated C₂₀ fatty acids are for example selected from the group consisting of gadoleic acid ((9Z)-eicosa-9-enoic acid), ecosenoic acid ((11Z)-eicosa-11-enoic acid), arachidonic acid ((5Z,8Z,11Z,14Z)-eicosa-5,8,11,14-tetraenoic acid) and timnodonic acid ((5Z,8Z,11Z,14Z,17Z)-eicosa-5,8,11,14,17-pentaenoic acid).

The component B1′) is especially preferably at least one C₃₆ dimer acid.

The at least one C₃₆ dimer acid is preferably produced from unsaturated C₁₈ fatty acids. It is particularly preferable when the C₃₆ dimer acid is produced from C₁₈ fatty acids selected from the group consisting of petroselic acid ((6Z)-octadeca-6-enoic acid), oleic acid ((9Z)-octadeca-9-enoic acid), elaidic acid ((9E)-octadeca-9-enoic acid), vaccenic acid ((11E)-octadeca-11-enoic acid) and linoleic acid ((9Z, 12Z)-octadeca-9,12-dienoic acid).

Production of the component B1′) from unsaturated fatty acids may also form trimer acids and residues of unconverted unsaturated fatty acid may also remain.

The formation of trimer acids is known to those skilled in the art.

According to the invention the component B1′) preferably comprises not more than 0.5 wt % of unreacted unsaturated fatty acid and not more than 0.5 wt % of trimer acid, particularly preferably not more than 0.2 wt % of unreacted unsaturated fatty acid and not more than 0.2 wt % of trimer acid, in each case based on the total weight of component B1′).

Dimer acids (also known as dimerized fatty acids or dimer fatty acids) are thus to be understood as meaning generally, and especially in the context of the present invention, mixtures produced by oligomerization of unsaturated fatty acids. They are producible for example by catalytic dimerization of plant-derived unsaturated fatty acids, wherein the starting materials employed are in particular unsaturated C₁₆ to C₂₀ fatty acids. The bonding proceeds primarily by the Diels-Alder mechanism, and results, depending on the number and position of the double bonds in the fatty acids used to produce the dimer acids, in mixtures of primarily dimeric products having cycloaliphatic, linear aliphatic, branched aliphatic, and also C₆ aromatic hydrocarbon groups between the carboxyl groups. Depending on the mechanism and/or any subsequent hydrogenation, the aliphatic radicals may be saturated or unsaturated and the proportion of aromatic groups may also vary. The radicals between the carboxylic acid groups then comprise 32 to 40 carbon atoms for example. Production preferably employs fatty acids having 18 carbon atoms so that the dimeric product thus has 36 carbon atoms. The radicals which join the carboxyl groups of the dimer fatty acids preferably comprise no unsaturated bonds and no aromatic hydrocarbon radicals.

In the context of the present invention production thus preferably employs C₁₈ fatty acids. It is particularly preferable to employ linolenic, linoleic and/or oleic acid.

Depending on reaction management the above described oligomerization affords mixtures which comprise primarily dimeric, but also trimeric, molecules and also monomeric molecules and other by-products. Purification by distillation is customary. Commercial dimer acids generally comprise at least 80 wt % of dimeric molecules, up to 19 wt % of trimeric molecules, and at most 1 wt % of monomeric molecules and of other by-products.

It is preferable to use dimer acids that consist to an extent of at least 90 wt %, preferably to an extent of at least 95 wt %, very particularly preferably to an extent of at least 98 wt % of dimeric fatty acid molecules.

The proportions of monomeric, dimeric, and trimeric molecules and of other by-products in the dimer acids may be determined by gas chromatography (GC), for example. The dimer acids are converted to the corresponding methyl esters by the boron trifluoride method (cf. DIN EN ISO 5509) before GC analysis and then analyzed by GC.

In the context of the present invention it is thus a fundamental feature of “dimer acids” that production thereof comprises oligomerization of unsaturated fatty acids. This oligomerization forms predominantly, i.e. preferably to an extent of at least 80 wt %, particularly preferably at least 90 wt %, very particularly preferably at least 95 wt % and in particular at least 98 wt %, dimeric products. The fact that the oligomerization thus forms predominantly dimeric products comprising precisely two fatty acid molecules justifies this designation which is in any case commonplace. An alternative expression for the relevant term “dimer acids” is thus “mixture comprising dimerized fatty acids”.

The dimer acids to be used are obtainable as commercial products. Examples include Radiacid 0970, Radiacid 0971, Radiacid 0972, Radiacid 0975, Radiacid 0976, and Radiacid 0977 from Oleon NV, Pripol 1006, Pripol 1009, Pripol 1012, and Pripol 1013 from Croda, Empol 1008, Empol 1012, Empol 1061, and Empol 1062 from BASF SE, and Unidyme 10 and Unidyme TI from Arizona Chemical.

The component B1′) has an acid number in the range from 190 to 200 mg KOH/g for example.

### Component B2′)

According to the invention the component B2′) is at least one C₄-C₁₂ diamine.

In the context of the present invention “at least one C₄-C₁₂ diamine” is to be understood as meaning either precisely one C₄-C₁₂ diamine or a mixture of two or more C₄-C₁₂ diamines.

In the context of the present compound, “C₄-C₁₂ diamine” is to be understood as meaning aliphatic and/or aromatic compounds having four to twelve carbon atoms and two amino groups

(—NH₂ groups). The aliphatic and/or aromatic compounds may be unsubstituted or additionally at least monosubstituted. If the aliphatic and/or aromatic compounds are additionally at least monosubstituted, they may bear one, two or more substituents that do not take part in the polymerization of the components A′) and B′). Such substituents are for example alkyl or cycloalkyl substituents. These are known per se to those skilled in the art. The at least one C₄-C₁₂ diamine is preferably unsubstituted.

Suitable components B2′) are for example selected from the group consisting of 1,4diaminobutane (butane-1,4-diamine; tetramethylenediamine; putrescine), 1,5-diaminopentane (pentamethylenediamine; pentane-1,5-diamine; cadaverine), 1,6-diaminohexane (hexamethylenediamine; hexane-1,6-diamine), 1,7-diaminoheptane, 1,8-diaminooctane, 1,9-diaminononane, 1,10-diaminodecane (decamethylenediamine), 1,11-diaminoundecane (undecamethylenediamine) and 1,12-diaminododecane (dodecamethylenediamine).

It is preferable when the component B2′) is selected from the group consisting of tetramethylenediamine, pentamethylenediamine, hexamethylenediamine, decamethylenediamine and dodecamethylenediamine.

### Component B3′)

According to the invention, the component B3′) optionally present in the component B′) is at least one C₄-C₂₀ diacid.

In the context of the present invention, “at least one C₄-C₂₀ diacid” is to be understood as meaning either precisely one C₄-C₂₀ diacid or a mixture of two or more C₄-C₂₀ diacids.

In the context of the present invention “C₄-C₂₀ diacid” is to be understood as meaning aliphatic and/or aromatic compounds having two to eighteen carbon atoms and two carboxyl groups (—COOH groups). The aliphatic and/or aromatic compounds may be unsubstituted or additionally at least monosubstituted. If the aliphatic and/or aromatic compounds are additionally at least monosubstituted, they may bear one, two or more substituents that do not take part in the polymerization of components A′) and B′). Such substituents are for example alkyl or cycloalkyl substituents. These are known to those skilled in the art. Preferably, the at least one C₄-C₂₀ diacid is unsubstituted.

Suitable components B3′) are for example selected from the group consisting of butanedioic acid (succinic acid), pentanedioic acid (glutaric acid), hexanedioic acid (adipic acid), heptanedioic acid (pimelic acid), octanedioic acid (suberic acid), nonanedioic acid (azelaic acid), decanedioic acid (sebacic acid), undecanedioic acid, dodecanedioic acid, tridecanedioic acid, tetradecanedioic acid and hexadecanedioic acid.

It is preferable when the component B3′) is selected from the group consisting of pentanedioic acid (glutaric acid), hexanedioic acid (adipic acid), decanedioic acid (sebacic acid) and dodecanedioic acid.

Most preferably, the at least one aliphatic polyamide of component A) is derived from Ecaprolactam (as component A′), at least one C₃₆ dimer acid (as component B1′) and hexamethylene diamine (as component B2′).

It is particularly preferable when the component is PA 6/6.36, preferably having a melting point of 190 to 210° C., specifically having a melting point of 195 to 200° C., more specifically 196 to 199° C., and/or a (polymerized) caprolactam content of 60 to 80 wt %, more preferably 65 to 75 wt %, specifically 67 to 70 wt %, the remainder being PA 6.36 units derived from hexamethylene diamine and C₃₆ diacid.

### Thermoplastic Molding Compositions

The present invention further relates to a thermoplastic molding composition comprising a polymer blend according to the present invention and at least one additional substance C).

The thermoplastic molding composition preferably comprises
i) 1 to 99.9 wt. % of a polymer blend comprising
   a) from >50 wt. % to 99 wt. % of at least one aliphatic copolyamide as component A);
   b) from 1 wt. % to <50 wt. % of at least one semicrystalline, semiaromatic or aromatic polyamide as component B);
   wherein the total of wt. % of components A) and B) is 100 wt. %; and
ii) 0.1 wt. % to 99 wt. % of at least one additional substance as component C),
   wherein the total of wt. % of the polymer blend and component C) is 100 wt. %

The at least one additional substance as component C) is selected from one or more of the following components:
C1) at least one fibrous and/or particulate filler;
C2) at least one impact modifier;
C3) at least one thermoplastic polymer distinct from components A), B), C2) and C4); and
C4) one or more further additives.

The present invention therefore further relates to a thermoplastic molding composition according to the present invention comprising as additional substance C) at least one fibrous and/or particulate filler as component C1).

The present invention therefore further relates to a thermoplastic molding composition according to the present invention comprising as additional substance C) at least one impact modifier as component C2).

The present invention therefore further relates to a thermoplastic molding composition according to the present invention comprising as additional substance C) at least one thermoplastic polymer distinct from components A), B), C2) and distinct from optional further additives, as component C3).

In one embodiment, the present invention relates to reinforced thermoplastic molding compositions TM1 comprising
i) 35 to 90 wt. %, preferably 35 to 70 wt. %, more preferably 40 to 60 wt. % of a polymer blend comprising
   a) from >50 wt. % to 99 wt. % of at least one aliphatic copolyamide as component A);
   b) from 1 wt. % to <50 wt. % of at least one semicrystalline, semiaromatic or aromatic polyamide as component B);
   wherein the total of wt. % of components A) and B) is 100 wt. %;
iia) 10 wt. % to 65 wt. %, preferably 30 to 65 wt. %, more preferably 40 to 60 wt. % of at least one fibrous and/or particulate filler as component C1), and
iib) 0 to 30 wt. %, preferably 0 to 20 wt. %, more preferably 0 to 10 wt. % of at least one impact modifier as component C2) and/or one or more further additives as component C4),
   wherein the total of wt. % of the polymer blend, component C1), C2) and C4) is 100 wt. %.

If present, the amount of components C2) and/or C4) in the thermoplastic molding compositions TM1 is 0.1 to 30% by weight, preferably 0.5 to 20% by weight, more preferably 1 to 10% by weight.

In a further embodiment, the present invention relates to impact modified thermoplastic molding compositions TM2 comprising
i) 35 to 90 wt. %, preferably 35 to 70 wt. %, more preferably 40 to 60 wt. % of a polymer blend comprising
   a) from >50 wt. % to 99 wt. % of at least one aliphatic copolyamide as component A);
   b) from 1 wt. % to <50 wt. % of at least one semicrystalline, semiaromatic or aromatic polyamide as component B);
   wherein the total of wt. % of components A) and B) is 100 wt. %;
iia) 0 wt. % to 65 wt. %, preferably 0 to 60 wt. % of at least one fibrous and/or particulate filler as component C1), and
iib) 1 to 25 wt. %, preferably 2 to 20 wt. %, more preferably 3 to 15 wt. % of at least one im-pact modifier as component C2); and
iic) one or more further additives as component C4),
   wherein the total of wt. % of the polymer blend, component C1), C2) and C4) is 100 wt. %.

If present, the amount of component C4) in the thermoplastic molding compositions TM2 is 0.1 to 30% by weight, preferably 0.5 to 20% by weight, more preferably 1 to 10% by weight.

In a further embodiment, the present invention relates to blended thermoplastic molding compositions TM3 comprising
i) 1 to 99.9 wt. %, preferably 1.2 to 98 wt. %, more preferably 1.5 to 90 wt. % of a polymer blend comprising
   a) from >50 wt. % to 99 wt. % of at least one aliphatic copolyamide as component A);
   b) from 1 wt. % to <50 wt. % of at least one semicrystalline, semiaromatic or aromatic polyamide as component B);
   wherein the total of wt. % of components A) and B) is 100 wt. %;
iia) 0.1 to 99 wt. %, preferably 2 to 98.8 wt. %, more preferably 10 to 98.5 wt. % of at least one thermoplastic polymer distinct from components A), B), C2) and C4), as component C3);
iib) 0 wt. % to 65 wt. %, preferably 0 to 60 wt. % of at least one fibrous and/or particulate filler as component C1), and
iic) 0 to 30 wt. %, preferably 0 to 20 wt. %, more preferably 0 to 10 wt. % of at least one im-pact modifier as component C2) and/or one or more further additives as component C4),
   wherein the total of wt. % of the polymer blend, component C1), C2) and C4) is 100 wt. %.

If present, the amount of components C2) and/or C4) in the thermoplastic molding compositions TM3 is 0.1 to 30% by weight, preferably 0.5 to 20% by weight, more preferably 1 to 10% by weight.

By blending the inventive blends with at least one thermoplastic polymer distinct from components A), B), C2) and C4), as component C3), it is possible to achieve a blending of thermoplastic polymers C3), generally having a melting point below the melting point of component B) with component B) of the inventive blends. Direct blending of thermoplastic polymers C3) with a melting point below the melting point of component B) with component B) would generally cause thermal degradation.

It is for example possible to blend a blend according to the present invention at 240° C. (e.g 30 w % ARLEN® C₂₀₀₀ from Mitsui Chemicals Europe GmbH (ArPA3) in 70 w % Ultramid® Flex F29 from BASF SE (AlCoPA 1)) with polypropylene. In contrast, a direct blending of the single polymers ArPA3, AlCoPA1 and polypropylene would cause thermal degradation of the polypropylene due to the high melting point of ArPA3 (310° C.).

Fibrous or particulate fillers C1) that may be mentioned are carbon fibers, glass fibers, glass beads, amorphous silica, calcium silicate, calcium metasilicate, magnesium carbonate, kaolin, chalk, powdered quartz, mica, barium sulfate, and feldspar.

Preferred fibrous fillers that may be mentioned are carbon fibers, aramid fibers, and potassium titanate fibers, particular preference being given to glass fibers in the form of E glass. These can be used as rovings or in the commercially available forms of chopped glass.

The fibrous fillers may have been surface-pretreated with a silane compound to improve compatibility with the thermoplastic.

Suitable silane compounds have the general formula:

(X—(CH₂)ₙ)ₖ—Si—(O—CₘH₂ₘ₊₁)₄₋ₖ

where the definitions of the substituents are as follows:

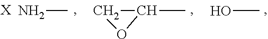

n is a whole number from 2 to 10, preferably 3 to 4,
m is a whole number from 1 to 5, preferably 1 to 2, and
k is a whole number from 1 to 3, preferably 1.

Preferred silane compounds are aminopropyltrimethoxysilane, aminobutyltrimethoxysilane, aminopropyltriethoxysilane and aminobutyltriethoxysilane, and also the corresponding silanes which comprise a glycidyl group as substituent X.

The amounts of the silane compounds generally used for surface-coating are from 0.01 to 2% by weight, preferably from 0.025 to 1.0% by weight and in particular from 0.05 to 0.5% by weight (based on C1)).

Acicular mineral fillers are also suitable. For the purposes of the invention, acicular mineral fillers are mineral fillers with strongly developed acicular character. An example is acicular wollastonite. The mineral preferably has an L/D (length to diameter) ratio of from 8:1 to 35:1, preferably from 8:1 to 11:1. The mineral filler may optionally have been pretreated with the abovementioned silane compounds, but the pretreatment is not essential.

Other fillers which may be mentioned are kaolin, calcined kaolin, wollastonite, talc and chalk, and also lamellar or acicular nanofillers, the amounts of these preferably being from 0.1 to 10% (based on the thermoplastic molding composition). Materials preferred for this purpose are boehmite, bentonite, montmorillonite, vermiculite, hectorite, and laponite. The lamellar nanofillers are organically modified by prior-art methods, to give them good compatibility with the organic binder. Addition of the lamellar or acicular nanofillers to the inventive nanocomposites gives a further increase in mechanical strength.

Impact modifier C2) (also often termed elastomeric polymers, elastomers, or rubbers) are very generally copolymers preferably composed of at least two of the following monomers: ethylene, C₃₋₁₈ α olefins like propylene, butene, octene, decene or isobutene, butadiene, isoprene, chloroprene, vinyl acetate, styrene, acrylonitrile and acrylates and/or methacrylates having from 1 to 18 carbon atoms in the alcohol component, which copolymers may be grafted for example with dicarbolylic acids or the corresponding anhydrides, like maleic acid or maleic acid anhydride. Examples are copolymers of ethylene and C₃₋₁₈ α olefins (as mentioned above) grafted with maleic anhydride, for example maleic anhydride grafted ethylene/octene copolymers and maleic anhydride grafted ethylene/proplyene copolymers.

Polymers of this type are described, for example, in Houben-Weyl, Methoden der organischen Chemie, vol. 14/1 (Georg-Thieme-Verlag, Stuttgart, Germany, 1961), pages 392-406, and in the monograph by C.B. Bucknall, “Toughened Plastics” (Applied Science Publishers, London, UK, 1977).

Some preferred types of such elastomers are described below.

Preferred types of such elastomers are those known as ethylene-propylene (EPM) and ethylene-propylene-diene (EPDM) rubbers.

EPM rubbers generally have practically no residual double bonds, whereas EPDM rubbers may have from 1 to 20 double bonds per 100 carbon atoms.

Examples which may be mentioned of diene monomers for EPDM rubbers are conjugated dienes, such as isoprene and butadiene, non-conjugated dienes having from 5 to 25 carbon atoms, such as 1,4-pentadiene, 1,4-hexadiene, 1,5-hexadiene, 2,5-dimethyl-1,5-hexadiene and 1,4-octadiene, cyclic dienes, such as cyclopentadiene, cyclohexadienes, cyclooctadienes and dicyclopentadiene, and also alkenylnorbornenes, such as 5-ethylidene-2-norbornene, 5-butylidene-2-norbornene, 2-methallyl-5-norbornene and 2-isopropenyl-5-norbornene, and tricycledienes, such as 3-methyltricyclo[5.2.1.0^{2.6}]-3,8-decadiene, and mixtures of these. Preference is given to 1,5-hexadiene, 5-ethylidenenorbornene and dicyclopentadiene. The diene content of the EPDM rubbers is preferably from 0.5 to 50% by weight, in particular from 1 to 8% by weight, based on the total weight of the rubber.

EPM rubbers and EPDM rubbers may preferably also have been grafted with reactive carboxylic acids or with derivatives of these. Examples of these are acrylic acid, methacrylic acid and derivatives thereof, e.g. glycidyl (meth)acrylate, and also maleic anhydride.

Copolymers of ethylene with acrylic acid and/or methacrylic acid and/or with the esters of these acids are another group of preferred rubbers. The rubbers may also comprise dicarboxylic acids, such as maleic acid and fumaric acid, or derivatives of these acids, e.g. esters and anhydrides, and/or monomers comprising epoxy groups. These dicarboxylic acid derivatives or monomers comprising epoxy groups are preferably incorporated into the rubber by adding to the monomer mixture monomers comprising dicarboxylic acid groups and/or epoxy groups and having the general formulae I or II or III or IV

R¹C(COOR²)═C(COOR³)R⁴ (I)

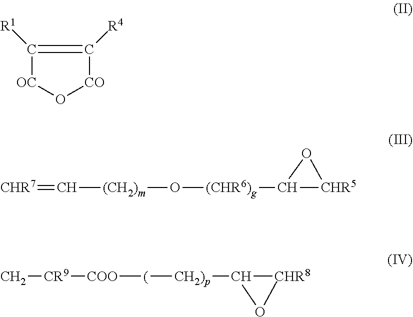

where R¹ to R⁹ are hydrogen or alkyl groups having from 1 to 6 carbon atoms, and m is a whole number from 0 to 20, g is a whole number from 0 to 10 and p is a whole number from 0 to 5.

The radicals R¹ to R⁹ are preferably hydrogen, where m is 0 or 1 and g is 1. The corresponding compounds are maleic acid, fumaric acid, maleic anhydride, allyl glycidyl ether and vinyl glycidyl ether.

Preferred compounds of the formulae I, II and IV are maleic acid, maleic anhydride and (meth)acrylates comprising epoxy groups, such as glycidyl acrylate and glycidyl methacrylate, and the esters with tertiary alcohols, such as tert-butyl acrylate. Although the latter have no free carboxy groups, their behavior approximates to that of the free acids and they are therefore termed monomers with latent carboxy groups.

The copolymers are advantageously composed of from 50 to 98% by weight of ethylene, from 0.1 to 20% by weight of monomers comprising epoxy groups and/or methacrylic acid and/or monomers comprising anhydride groups, the remaining amount being (meth)acrylates.

Particular preference is given to copolymers composed of
from 50 to 98% by weight, in particular from 55 to 95% by weight, of ethylene,
from 0.1 to 40% by weight, in particular from 0.3 to 20% by weight, of glycidyl acrylate and/or glycidyl methacrylate, (meth)acrylic acid and/or maleic anhydride, and
from 1 to 45% by weight, in particular from 5 to 40% by weight, of n-butyl acrylate and/or 2-ethylhexyl acrylate;
   wherein the total of wt. % of the copolymers is 100 wt. %.

Other preferred (meth)acrylates are the methyl, ethyl, propyl, isobutyl and tert-butyl esters.

Comonomers which may be used alongside these are vinyl esters and vinyl ethers.

The ethylene copolymers described above may be prepared by processes known per se, preferably by random copolymerization at high pressure and elevated temperature. Appropriate processes are well-known.

Other preferred elastomers are emulsion polymers whose preparation is described, for example, by Blackley in the monograph “Emulsion Polymerization”. The emulsifiers and catalysts which can be used are known per se.

In principle it is possible to use homogeneously structured elastomers or else those with a shell structure. The shell-type structure is determined by the sequence of addition of the individual monomers. The morphology of the polymers is also affected by this sequence of addition.

Monomers which may be mentioned here, merely as examples, for the preparation of the rubber fraction of the elastomers are acrylates, such as, for example, n-butyl acrylate and 2-ethylhexyl acrylate, corresponding methacrylates, butadiene and isoprene, and also mixtures of these. These monomers may be copolymerized with other monomers, such as, for example, styrene, acrylonitrile, vinyl ethers and with other acrylates or methacrylates, such as methyl methacrylate, methyl acrylate, ethyl acrylate or propyl acrylate.

The soft or rubber phase (with a glass transition temperature of below 0° C.) of the elastomers may be the core, the outer envelope or an intermediate shell (in the case of elastomers whose structure has more than two shells). Elastomers having more than one shell may also have more than one shell composed of a rubber phase.

If one or more hard components (with glass transition temperatures above 20° C.) are involved, besides the rubber phase, in the structure of the elastomer, these are generally prepared by polymerizing, as principal monomers, styrene, acrylonitrile, methacrylonitrile, α-methylstyrene, p-methylstyrene, or acrylates or methacrylates, such as methyl acrylate, ethyl acrylate or methyl methacrylate. Besides these, it is also possible to use relatively small proportions of other comonomers.

It has proven advantageous in some cases to use emulsion polymers which have reactive groups at their surfaces. Examples of groups of this type are epoxy, carboxy, latent carboxy, amino and amide groups, and also functional groups which may be introduced by concomitant use of monomers of the general formula

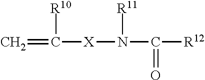

where the substituents can be defined as follows:
R¹⁰ is hydrogen or a C₁-C₄-alkyl group,
R¹¹ is hydrogen, a C₁-C₈-alkyl group or an aryl group, in particular phenyl,
R¹² is hydrogen, a C₁-C₁₀-alkyl group, a C₆-C₁₂-aryl group, or —OR¹³,
R¹³ is a C₁-C₈-alkyl group or a C₆-C₁₂-aryl group, which can optionally have substitution by groups that comprise O or by groups that comprise N,
X is a chemical bond, a C₁-C₁₀-alkylene group, or a C₆-C₁₂-arylene group, or

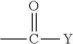

Y is O—Z or NH—Z, and
Z is a C₁-C₁₀-alkylene or C₆-C₁₂-arylene group.

The graft monomers described in EP-A 208 187 are also suitable for introducing reactive groups at the surface.

Other examples which may be mentioned are acrylamide, methacrylamide and substituted acrylates or methacrylates, such as (N-tert-butylamino)ethyl methacrylate, (N,N-dimethylamino)ethyl acrylate, (N,N-dimethylamino)methyl acrylate and (N,N-diethylamino)ethyl acrylate.

The particles of the rubber phase may also have been crosslinked. Examples of crosslinking monomers are 1,3-butadiene, divinylbenzene, diallyl phthalate and dihydrodicyclopentadienyl acrylate, and also the compounds described in EP-A 50 265.

It is also possible to use the monomers known as graft-linking monomers, i.e. monomers having two or more polymerizable double bonds which react at different rates during the polymerization. Preference is given to the use of compounds of this type in which at least one reactive group polymerizes at about the same rate as the other monomers, while the other reactive group (or reactive groups), for example, polymerize(s) significantly more slowly. The different polymerization rates give rise to a certain proportion of unsaturated double bonds in the rubber. If another phase is then grafted onto a rubber of this type, at least some of the double bonds present in the rubber react with the graft monomers to form chemical bonds, i.e. the phase grafted on has at least some degree of chemical bonding to the graft base.

Examples of graft-linking monomers of this type are monomers comprising allyl groups, in particular allyl esters of ethylenically unsaturated carboxylic acids, for example allyl acrylate, allyl methacrylate, diallyl maleate, diallyl fumarate and diallyl itaconate, and the corresponding monoallyl compounds of these dicarboxylic acids. Besides these there is a wide variety of other suitable graft-linking monomers. For further details reference may be made here, for example, to U.S. Pat. No. 4,148,846.

The proportion of these crosslinking monomers in the impact-modifying polymer is generally up to 5% by weight, preferably not more than 3% by weight, based on the impact-modifying polymer.

Some preferred emulsion polymers are listed below. Mention may first be made here of graft polymers with a core and with at least one outer shell, and having the following structure:

| Type | Monomers for the core | Monomers for the envelope |
|---|---|---|
| I | 1,3-butadiene, isoprene, | styrene, acrylonitrile, methyl |
| | n-butyl acrylate, ethylhexyl | methacrylate |
| | acrylate, or a mixture of | |
| | these | |
| II | as I, but with concomitant | as I |
| | use of crosslinking agents | |
| III | as I or II | n-butyl acrylate, ethyl acrylate, |
| | | methyl acrylate, 1,3-butadiene, |
| | | isoprene, ethylhexyl acrylate |
| IV | as I or II | as I or III, but with concomitant |
| | | use of monomers having reactive |
| | | groups, as described herein |
| V | styrene, acrylonitrile, | first envelope composed of |
| | methyl methacrylate, or a | monomers as described under I and |
| | mixture of these | II for the core, second envelope |
| | | as described under I or IV for |
| | | the envelope |

Instead of graft polymers whose structure has more than one shell, it is also possible to use homogeneous, i.e. single-shell, elastomers composed of 1,3-butadiene, isoprene and n-butyl acrylate or of copolymers of these. These products, too, may be prepared by concomitant use of crosslinking monomers or of monomers having reactive groups.

Examples of preferred emulsion polymers are n-butyl acrylate-(meth)acrylic acid copolymers, n-butyl acrylate/glycidyl acrylate or n-butyl acrylate/glycidyl methacrylate copolymers, graft polymers with an inner core composed of n-butyl acrylate or based on butadiene and with an outer envelope composed of the abovementioned copolymers, and copolymers of ethylene with comonomers which supply reactive groups.

The elastomers described may also be prepared by other conventional processes, e.g. by suspension polymerization.

Preference is also given to silicone rubbers, as described in DE-A 37 25 576, EP-A 235 690, DE-A 38 00 603 and EP-A 319 290.

It is, of course, also possible to use mixtures of the types of rubber listed above.

Preferred thermoplastic polymers distinct from components A), B), C2) and C4), as component C3) are polymers having a melting point of <300° C., preferably <280° C.

Examples for suitable thermoplastic polymers distinct from components A), B), C2) and C4), as component C3) are preferably selected from
homo- or copolymers which comprise in copolymerized form at least one monomer selected from C₂-C₁₀-monoolefins, for example ethylene or propylene, 1,3-butadiene, 2-chloro-1,3-butadiene, vinyl alcohol and the C₂-C₁₀-alkyl esters thereof, vinyl chloride, vinylidene chloride, vinylidene fluoride, tetrafluoroethylene, glycidyl acrylate, glycidyl methacrylate, acrylates and methacrylates having alcohol components of branched and unbranched C₁-C₁₀-alcohols, vinylaromatics, for example styrene, acrylonitrile, methacrylonitrile, α,β-ethylenically unsaturated mono- and dicarboxylic acids, and maleic anhydride;
polyamides distinct from components A and B, for example amorphous polyamides;
homo- and copolymers of vinyl acetals;
polyvinyl esters;
polycarbonates (PC);
polyesters such as polyalkylene terephthalates, polyhydroxyalkanoates (PHA), poly-butylene succinates (PBS), polybutylene succinate adipates (PBSA);
polyethers;
polyether ketones;
thermoplastic polyurethanes (TPU);
polysulfides;
polysulfones;
polyether sulfones;
cellulose alkyl esters;
   and mixtures thereof.

Examples include polyolefins, acrylonitrile-butadiene-styrene copolymers (ABS), ethylene-propylene copolymers, ethylene-propylene-diene copolymers (EPDM), polystyrene (PS), styrene-acrylonitrile copolymers (SAN), acrylonitrile-styrene-acrylate (ASA), styrene-butadiene-methyl methacrylate copolymers (SBMMA), styrene-maleic anhydride copolymers, styrene-methacrylic acid copolymers (SMA), amorphous polyamides, polyacrylates having identical or different alcohol radicals from the group of C₄-C₈ alcohols, particularly of butanol, hexanol, octanol and 2-ethylhexanol, polymethylmethacrylate (PMMA), methyl methacrylate-butyl acrylate copolymers, polyoxymethylene (POM), polyvinyl alcohol (PVAL), polyvinyl acetate (PVA), polyvinyl butyral (PVB), polycaprolactone (PCL), polyhydroxybutyric acid (PHB), polyhydroxyvaleric acid (PHV), polylactic acid (PLA), ethyl cellulose (EC), cellulose acetate (CA), cellulose propionate (CP) or cellulose acetate/butyrate (CAB).

Suitable further additives C4) are exemplified in the following as components C4₁) to C4₈).

The molding compositions of the invention can comprise, as component C4₁), from 0.05 to 3% by weight, preferably from 0.1 to 1.5% by weight, and in particular from 0.1 to 1% by weight, based on the thermoplastic molding composition, of a lubricant.

Preference is given to the salts of Al, of alkali metals, or of alkaline earth metals, or esters or amides of fatty acids having from 10 to 44 carbon atoms, preferably having from 12 to 44 carbon atoms.

The metal ions are preferably alkaline earth metal and Al, particular preference being given to Ca or Mg.

Preferred metal salts are Ca stearate and Ca montanate, and also Al stearate.

It is also possible to use a mixture of various salts, in any desired mixing ratio.

The carboxylic acids can be monobasic or dibasic. Examples which may be mentioned are pelargonic acid, palmitic acid, lauric acid, margaric acid, dodecanedioic acid, behenic acid, and particularly preferably stearic acid, capric acid, and also montanic acid (a mixture of fatty acids having from 30 to 40 carbon atoms).

The aliphatic alcohols can be monohydric to tetrahydric. Examples of alcohols are n-butanol, n-octanol, stearyl alcohol, ethylene glycol, propylene glycol, neopentyl glycol, pentaerythritol, preference being given to glycerol and pentaerythritol.

The aliphatic amines can be mono- to tribasic. Examples of these are stearylamine, ethylenediamine, propylenediamine, hexamethylenediamine, di(6-aminohexyl)amine, particular preference being given to ethylenediamine and hexamethylenediamine. Preferred esters or amides are correspondingly glycerol distearate, glycerol tristearate, ethylenediamine distearate, glycerol monopalmitate, glycerol trilaurate, glycerol monobehenate, and pentaerythritol tetrastearate.

It is also possible to use a mixture of various esters or amides, or of esters with amides in combination, in any desired mixing ratio.

The molding compositions of the invention can comprise, as component C4₂), from 0.05 to 3% by weight, preferably from 0.1 to 1.5% by weight, and in particular from 0.1 to 1% by weight, based on the thermoplastic molding composition, of a Cu(I) salt as stabilizer, preferably of a Cu(I) halide, in particular in a mixture with an alkali metal halide, preferably KI, in particular in the ratio 1:4.

Preferred salts of monovalent copper used are cuprous acetate, cuprous chloride, cuprous bromide, and cuprous iodide. The materials comprise these in amounts of from 5 to 500 ppm of copper, preferably from 10 to 250 ppm, based on polyamide (i.e. the polyamide blend according to the present invention).

The advantageous properties are in particular obtained if the copper is present with molecular distribution in the polyamide. This is achieved if a concentrate comprising the polyamide, and comprising a salt of monovalent copper, and comprising an alkali metal halide in the form of a solid, homogeneous solution is added to the molding composition. By way of example, a typical concentrate is composed of from 79 to 95% by weight of polyamide and from 21 to 5% by weight of a mixture composed of copper iodide or copper bromide and potassium iodide. The copper concentration in the solid homogeneous solution is preferably from 0.3 to 3% by weight, in particular from 0.5 to 2% by weight, based on the total weight of the solution, and the molar ratio of cuprous iodide to potassium iodide is from 1 to 11.5, preferably from 1 to 5.

According to one embodiment of the present invention, the molding compositions are free from copper iodide and potassium iodide and especially free from metal halides.

Suitable polyamides for the concentrate are homopolyamides and copolyamides, in particular nylon-6 and nylon-6,6.

The molding compositions of the invention can comprise, as component C4₃) oxidation retarders/antioxidants and/or heat stabilizers. Examples of oxidation retarders/antioxidants and heat stabilizers are sterically hindered phenols and/or phosphites and amines (e.g. TAD), hydroquinones, aromatic secondary amines, such as diphenylamines, various substituted members of these groups, and mixtures of these, in concentrations of up to 3% by weight, more preferably up to 1.5% by weight, most preferably up to 1% by weight, based on the weight of the thermoplastic molding compositions.

Suitable sterically hindered phenols are in principle all of the compounds which have a phenolic structure and which have at least one bulky group on the phenolic ring.

It is preferable to use, for example, compounds of the formula

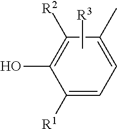

where:
R¹ and R² are an alkyl group, a substituted alkyl group, or a substituted triazole group, and where the radicals R¹ and R² may be identical or different, and R³ is an alkyl group, a substituted alkyl group, an alkoxy group, or a substituted amino group.

Antioxidants of the abovementioned type are described by way of example in DE-A 27 02 661 (U.S. Pat. No. 4,360,617).

Another group of preferred sterically hindered phenols is provided by those derived from substituted benzenecarboxylic acids, in particular from substituted benzenepropionic acids.

Particularly preferred compounds from this class are compounds of the formula

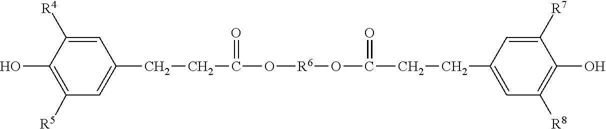

where R⁴, R⁵, R⁷, and R⁸, independently of one another, are C₁-C₈-alkyl groups which themselves may have substitution (at least one of these being a bulky group), and R⁶ is a divalent aliphatic radical which has from 1 to 10 carbon atoms and whose main chain may also have C—O bonds.

Preferred compounds corresponding to these formulae are

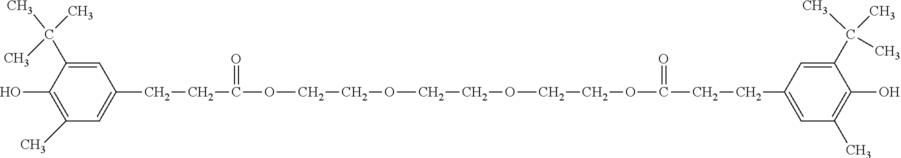 [SMILES: Cc1cc(CCC(=O)OCCOCCOCCOC(=O)CCc2cc(C)c(O)c(C(C)(C)C)c2)cc(C(C)(C)C)c1O]

(Irganox® 245 from BASF SE)

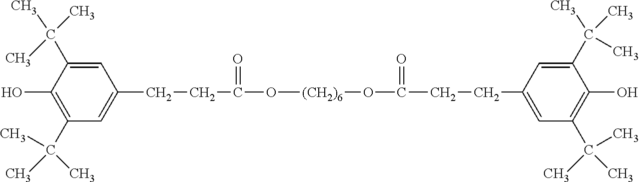

(Irganox® 259 from BASF SE)

All of the following should be mentioned as examples of sterically hindered phenols:
2,2′-methylenebis(4-methyl-6-tert-butylphenol), 1,6-hexanediol bis[3-(3,5-di-tert-butyl-4-hydroxyphenyl)propionate], pentaerythrityl tetrakis[3-(3,5-di-tert-butyl-4-hydroxyphenyl)propionate], distearyl 3,5-di-tert-butyl-4-hydroxybenzylphosphonate, 2,6,7-trioxa-1-phosphabicyclo[2.2.2]oct-4-ylmethyl 3,5-di-tert-butyl-4-hydroxyhydrocinnamate, 3,5-di-tert-butyl-4-hydroxyphenyl-3,5-distearylthiotriazylamine, 2-(2′-hydroxy-3′-hydroxy-3′,5′-di-tert-butylphenyl)-5-chlorobenzotriazole, 2,6-di-tert-butyl-4-hydroxymethylphenol, 1,3,5-trimethyl-2,4,6-tris(3,5-di-tert-butyl-4-hydroxybenzyl)benzene, 4,4′-methylenebis(2,6-di-tert-butylphenol), 3,5-di-tert-butyl-4-hydroxybenzyldimethylamine.

Compounds which have proven particularly effective and which are therefore used with preference are 2,2′-methylenebis(4-methyl-6-tert-butylphenol), 1,6-hexanediol bis(3,5-di-tert-butyl-4-hydroxyphenyl)propionate (Irganox® 259), pentaerythrityl tetrakis[3-(3,5-di-tert-butyl-4-hydroxyphenyl)propionate], and also N,N′-hexamethylenebis-3,5-di-tert-butyl-4-hydroxyhydrocinnamide (Irganox® 1098), and the product Irganox® 245 described above from BASF SE, which has particularly good suitability.

The amount comprised of the antioxidants C4₃), which can be used individually or as a mixture, is from 0.05 up to 3% by weight, preferably from 0.1 to 1.5% by weight, in particular from 0.1 to 1% by weight, based on the total weight of the molding compositions.

In some instances, sterically hindered phenols having not more than one sterically hindered group in ortho-position with respect to the phenolic hydroxy group have proven particularly advantageous; in particular when assessing colorfastness on storage in diffuse light over prolonged periods.

As component C4₄) the thermoplastic molding materials can generally comprise 1.0 to 10.0 wt %, preferably 2.0 to 6.0, in particular 3.0 to 5.0 wt %, based on the weight of the thermoplastic molding composition, of at least one flame retardant (if no other amount is explicitly stated).

Preferred flame retardants are phosphazenes.

“Phosphazenes” is to be understood as meaning cyclic phosphazenes of general formula (IX)

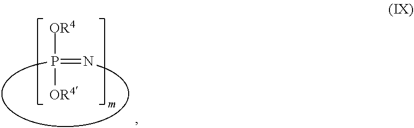

in which m is an integer from 3 to 25 and R⁴ and R^{4′} are identical or different and represent C₁-C₂₀-alkyl-, C₆-C₃₀-aryl-, C₆-C₃₀-arylalkyl- or C₆-C₃₀-alkyl-substituted aryl or linear phosphazenes of general formula (X)

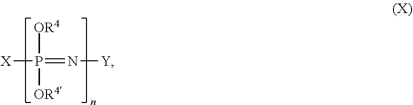

in which n represents 3 to 1000 and X represents —N=P(OPh)₃ or —N=P(O)OPh and Y represents —P(OPh)₄ or —P(O)(OPh)₂.

The production of such phosphazenes is described in EP-A 0 945 478.

Particular preference is given to cyclic phenoxyphosphazenes of formula P₃N₃C₃₆ of formula (XI)

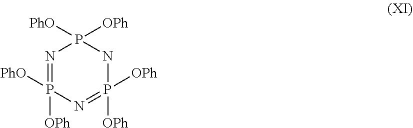

or linear phenoxyphosphazenes according to formula (XII)

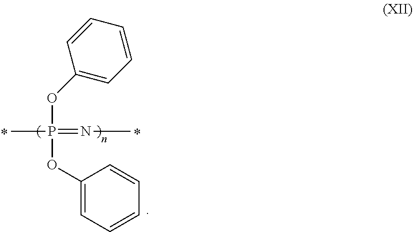 [SMILES: CN=P(C)(Oc1ccccc1)Oc1ccccc1]

The phenyl radicals may optionally be substituted. Phosphazenes in the context of the present application are described in Mark, J.E., Allcock, H. R., West, R., “Inorganic Polymers”, Prentice Hall, 1992, pages 61 to 141.

Preferably employed as component C4₄) are cyclic phenoxyphosphazenes having at least three phenoxyphosphazene units. Corresponding phenoxyphosphazenes are described for example in US 2010/0261818 in paragraphs to [0053]. Reference may in particular be made to formula (I) therein. Corresponding cyclic phenoxyphosphazenes are furthermore described in EP-A-2 100 919, in particular in paragraphs to therein. Production may be effected as described in EP-A-2 100 919 in paragraph [0041]. In one embodiment of the invention the phenyl groups in the cyclic phenoxyphosphazene may be substituted by C₁₋₄-alkyl radicals. It is preferable when pure phenyl radicals are concerned.

For further description of the cyclic phosphazenes reference may be made to Römpp Chemie Lexikon, 9^{th} ed., keyword “phosphazenes”. Production is effected for example via cyclophosphazene which is obtainable from PCl₅ and NH₄Cl, wherein the chlorine groups in the cyclophosphazene have been replaced by phenoxy groups by reaction with phenol.

The cyclic phenoxy phosphazene compound may for example be produced as described in Allcock, H. R., “Phosphorus-Nitrogen Compounds” (Academic Press, 1972), and in Mark, J. E., Allcock, H. R., West, R., “Inorganic Polymers” (Prentice Hall, 1992).

Component C4₄) is preferably a mixture of cyclic phenoxyphosphazenes having three and four phenoxy phosphazene units. The weight ratio of rings comprising three phenoxyphosphazene units to rings comprising four phenoxyphosphazene units is preferably about 80:20. Larger rings of the phenoxyphosphazene units may likewise be present but in smaller amounts. Suitable cyclic phenoxyphosphazenes are obtainable from Fushimi Pharmaceutical Co., Ltd., under the name Rabitle® FP-100. This is a matt-white/yellowish solid having a melting point of 110° C., a phosphorus content of 13.4% and a nitrogen content of 6.0%. The proportion of rings comprising three phenoxyphosphazene units is at least 80.0 wt %.

The thermoplastic molding materials preferably comprise 1.0 to 6.0 wt %, preferably 2.5 to 5.5 wt %, in particular 3.0 to 5.0 wt %, based on the amount of the thermoplastic molding composition, of at least one aliphatic or aromatic ester of phosphoric acid or polyphosphoric acid as flame retardant.

For this reason especially solid, non-migrating phosphate esters having a melting point between 70° C. and 150° C. are preferred. This has the result that the products are easy to meter and exhibit markedly less migration in the molding material. Particularly preferred examples are the commercially available phosphate esters PX-200® (CAS: 139189-30-3) from Daihachi, or Sol-DP® from ICL-IP. Further phosphate esters with appropriate substitution of the phenyl groups are conceivable when this allows the preferred melting range to be achieved. The general structural formula, depending on the substitution pattern in the ortho position or the para position on the aromatic ring, is as follows:

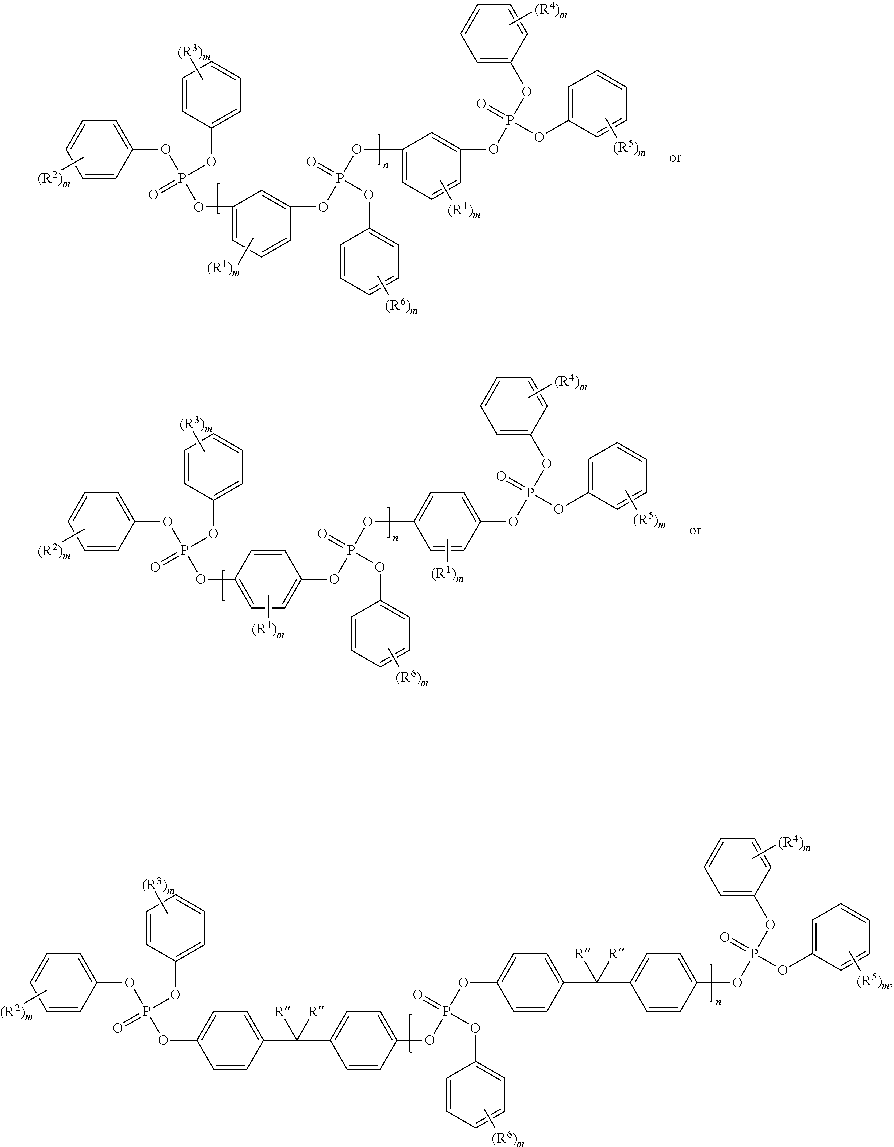

wherein
R¹⁼H, methyl, ethyl or isopropyl, but preferably H.
n=between 0 and 7, but preferably 0.
R²⁻⁶=H, methyl, ethyl or isopropyl, but preferably methyl. R⁶ is preferably identical to R⁴ and R^{5.}
m=may be but need not be identical and is between 1, 2, 3, 4 and 5, but preferably 2.
R″=may be H, methyl, ethyl or cyclopropyl, but preferably methyl and H.

PX-200 is given as a concrete example:

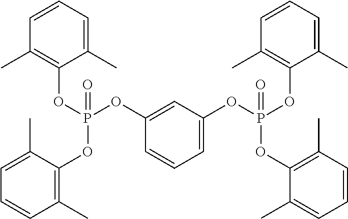 [SMILES: Cc1cccc(C)c1OP(=O)(Oc1cccc(OP(=O)(Oc2c(C)cccc2C)Oc2c(C)cccc2C)c1)Oc1c(C)cccc1C]

It is particularly preferable when at least one aromatic ester of polyphosphoric acid is employed. Such aromatic polyphosphates are obtainable for example from Daihachi Chemical under the name PX-200.

As component C4₄) the thermoplastic molding materials according to the invention can comprise 5.0 to 30.0 wt %, preferably 10.0 to 30.0 wt %, in particular 12.0 to 20.0 wt %, for example about 16.0 wt %, based on the amount of the thermoplastic molding composition, of at least one metal phosphinate or phosphinic acid salt described hereinbelow as flame retardant.

Examples of preferred flame retardants of component C4₄) are metal phosphinates derived from hypophosphorous acid. A metal salt of hypophosphorous acid with Mg, Ca, Al or Zn as the metal may be employed for example. Particular preference is given here to aluminum hypophosphite.

Also suitable are phosphinic acid salts of formula (I) or/and diphosphinic acid salts of formula (II) or polymers thereof

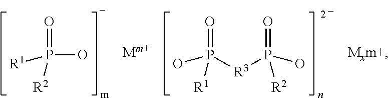

in which
R¹, R² are identical or different and represent hydrogen, C₁-C₆-alkyl, linear or branched, and/or aryl;
R³ represents C₁-C₁₀-alkylene, linear or branched, C₆-C₁₀-arylene, -alkylarylene or -arylalkylene;
M represents Mg, Ca, Al, Sb, Sn, Ge, Ti, Zn, Fe, Zr, Ce, Bi, Sr, Mn, Li, Na, K and/or a protonated nitrogen base;
m=1 to 4; n=1 to 4; x=1 to 4, preferably m=3, x=3.

Preferably, R¹, R² are identical or different and represent hydrogen, methyl, ethyl, n-propyl, isopropyl, n-butyl, tert.-butyl, n-pentyl and/or phenyl.

Preferably, R³ represents methylene, ethylene, n-propylene, isopropylene, n-butylene, tert-butylene, n-pentylene, n-octylene or n-dodecylene, phenylene or naphthylene; methylphenylene, ethylphenylene, tert-butylphenylene, methylnaphthylene, ethylnaphthylene or tert-butylnaphthylene; phenylmethylene, phenylethylene, phenylpropylene or phenylbutylene.

Particularly preferably, R¹, R² are hydrogen, methyl or ethyl, and M is Al, particular preference is given to Al hypophosphite.

Production of the phosphinates is preferably effected by precipitation of the corresponding metal salts from aqueous solutions. However, the phosphinates may also be precipitated in the presence of a suitable inorganic metal oxide or sulfide as support material (white pigments, for example TiO₂, SnO₂, ZnO, ZnS, SiO₂). This accordingly affords surface-modified pigments which can be employed as laser-markable flame retardants for thermoplastic polyesters.

It is preferable when metal salts of substituted phosphinic acids are employed in which compared to hypophosphorous acid one or two hydrogen atoms have been replaced by phenyl, methyl, ethyl, propyl, isobutyl, isooctyl or radicals R′—CH—OH have been replaced by R′-hydrogen, phenyl, tolyl. The metal is preferably Mg, Ca, Al, Zn, Ti, Fe. Aluminum diethylphosphinate (DEPAL) is particularly preferred.

For a description of phosphinic acid salts or diphosphinic acid salts reference may be made to DE-A 199 60 671 and also to DE-A 44 30 932 and DE-A 199 33 901.

Further flame retardants are, for example, halogen-containing flame retardants.

Suitable halogen-containing flame retardants are preferably brominated compounds, such as brominated diphenyl ether, brominated trimethylphenylindane (FR 1808 from DSB) tetrabromobisphenol A and hexabromocyclododecane.

Suitable flame retardants are preferably brominated compounds, such as brominated oligocarbonates (BC 52 or BC 58 from Great Lakes) having the structural formula:

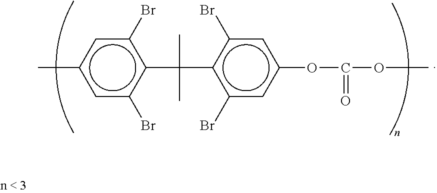

Especially suitable are polypentabromobenzyl acrylates where n>4 (e.g. FR 1025 from ICL-IP having the formula:

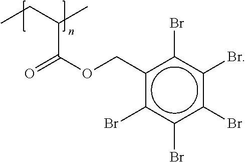

Preferred brominated compounds further include oligomeric reaction products (n>3) of tetra-bromobisphenol A with epoxides (e.g. FR 2300 and 2400 from DSB) having the formula:

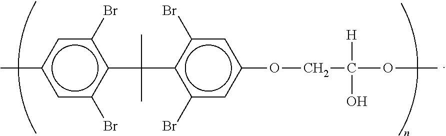

The brominated oligostyrenes preferably employed as flame retardants have an average degree of polymerization (number-average) between 3 and 90, preferably between 5 and 60, measured by vapor pressure osmometry in toluene. Cyclic oligomers are likewise suitable. In a preferred embodiment of the invention the brominated oligomeric styrenes have the formula I shown below in which R represents hydrogen or an aliphatic radical, in particular an alkyl radical, for example CH₂ or C₂H₅, and n represents the number of repeating chain building blocks. R¹ may be H or else bromine or else a fragment of a customary free radical former:

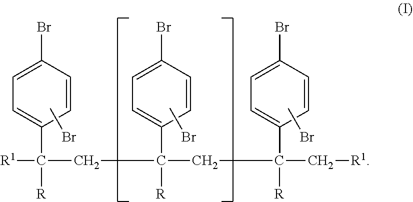

The value n may be 1 to 88, preferably 3 to 58. The brominated oligostyrenes comprise 40.0 to 80.0 wt %, preferably 55.0 to 70.0 wt %, of bromine. Preference is given to a product consisting predominantly of polydibromostyrene. The substances are meltable without decomposing, and soluble in tetrahydrofuran for example. Said substances may be produced either by ring bromination of—optionally aliphatically hydrogenated—styrene oligomers such as are obtained for example by thermal polymerization of styrene (according to DT-OS 25 37 385) or by free-radical oligomerization of suitable brominated styrenes. The production of the flame retardant may also be effected by ionic oligomerization of styrene and subsequent bromination. The amount of brominated oligostyrene necessary for endowing the polyamides with flame-retardant properties depends on the bromine content. The bromine content in the thermoplastic molding compositions according to the invention is preferably from 2.0 to 30.0 wt %, more preferably from 5.0 to 12.0 wt %, based on the amount of the thermoplastic molding composition.

The brominated polystyrenes according to the invention are typically obtained by the process described in EP-A 047 549:

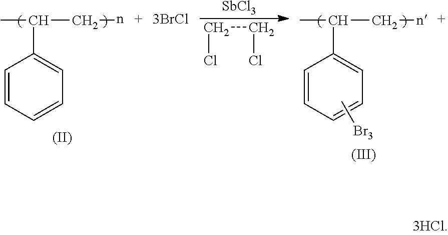

The brominated polystyrenes obtainable by this process and commercially available are predominantly ring-substituted tribrominated products. n′ (see III) generally has values of 125 to 1500 which corresponds to a molecular weight of 42500 to 235000, preferably of 130000 to 135000.

The bromine content (based on the content of ring-substituted bromine) is generally at least 50.0 wt %, preferably at least 60.0 wt % and in particular 65.0 wt %.

The commercially available pulverulent products generally have a glass transition temperature of 160° C. to 200° C. and are for example obtainable under the names HP 7010 from Albemarle and Pyrocheck® PB 68 from Ferro Corporation.

Mixtures of the brominated oligostyrenes with brominated polystyrenes may also be employed in the molding materials according to the invention, the mixing ratio being freely choosable.

Also suitable are chlorine-containing flame retardants, Declorane plus from Oxychem being preferable.

Suitable halogen-containing flame retardants are preferably ring-brominated polystyrene, brominated polybenzyl acrylates, brominated bisphenol A epoxide oligomers or brominated bisphenol A polycarbonates.

In one embodiment of the invention no halogen-containing flame retardants are employed in the thermoplastic molding materials according to the invention.

A flame-retardant melamine compound suitable as component C4₄) in the context of the present invention is a melamine compound which when added to glass fiber filled polyamide molding materials reduces flammability and influences fire behavior in a fire retarding fashion, thus resulting in improved properties in the UL 94 tests and in the glow wire test.

The melamine compound is for example selected from melamine borate, melamine phosphate, melamine sulfate, melamine pyrophosphate, melam, melem, melon or melamine cyanurate or mixtures thereof.

The melamine cyanurate preferentially suitable according to the invention is a reaction product of preferably equimolar amounts of melamine (formula I) and cyanuric acid/isocyanuric acid (formulae Ia and Ib).

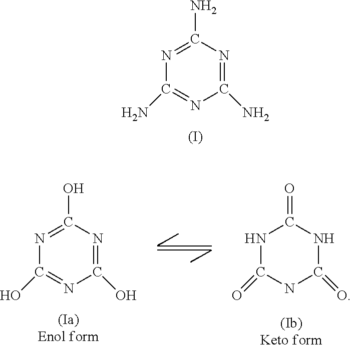

It is obtained for example by reaction of aqueous solutions of the starting compounds at 90° C. to 100° C. The commercially available product is a white powder having an average grain size d50 of 1.5 to 7 μm and a d₉₉ value of less than 50 μm.

Further suitable compounds (often also described as salts or adducts) are melamine sulfate, melamine, melamine borate, oxalate, phosphate prim., phosphate sec. and pyrophosphate sec., melamine neopentyl glycol borate. According to the invention the molding materials are preferably free from polymeric melamine phosphate (CAS No. 56386-64-2 or 218768-84-4).

This is to be understood as meaning melamine polyphosphate salts of a 1,3,5-triazine compound which have an average degree of condensation number n between 20 and 200 and a 1,3,5-triazine content of 1.1 to 2.0 mol of a 1,3,5-triazine compound selected from the group consisting of melamine, melam, melem, melon, ammeline, ammelide, 2-ureidomelamine, acetoguanamine, benzoguanamine and diaminophenyltriazine per mole of phosphorus atom. Preferably, the n-value of such salts is generally between 40 and 150 and the ratio of a 1,3,5-triazine compound per mole of phosphorus atom is preferably between 1.2 and 1.8. Furthermore, the pH of a 10 wt % aqueous slurry of salts produced according to EP-B1 095 030 will generally be more than 4.5 and preferably at least 5.0. The pH is typically determined by adding 25 g of the salt and 225 g of clean water at 25° C. into a 300 ml beaker, stirring the resultant aqueous slurry for 30 minutes and then measuring the pH. The abovementioned n-value, the number-average degree of condensation, may be determined by means of 31P solid-state NMR. J. R. van Wazer, C. F. Callis, J. Shoolery and R. Jones, J. Am. Chem. Soc., 78, 5715, 1956 discloses that the number of adjacent phosphate groups gives a unique chemical shift which permits clear distinction between orthophosphates, pyrophosphates, and polyphosphates.

Suitable guanidine salts are

| | CAS No. |
|---|---|
| g carbonate | 593-85-1 |
| g cyanurate prim. | 70285-19-7 |
| g phosphate prim. | 5423-22-3 |
| g phosphate sec. | 5423-23-4 |
| g sulfate prim. | 646-34-4 |
| g sulfate sec. | 594-14-9 |
| guanidine pentaerythritol borate | n.a. |
| guanidine neopentyl glycol borate | n.a. |
| and urea phosphate green | 4861-19-2 |
| urea cyanurate | 57517-11-0 |
| ammeline | 645-92-1 |
| ammelide | 645-93-2 |
| melem | 1502-47-2 |
| melon | 32518-77-7 |

In the context of the present invention “compounds” is to be understood as meaning not only for example benzoguanamine itself and the adducts/salts thereof but also the nitrogensubstituted derivatives and the adducts/salts thereof.

Also suitable are ammonium polyphosphate (NH₄PO₃)n where n is about 200 to 1000, preferably 600 to 800, and tris(hydroxyethyl)isocyanurate (THEIC) of formula IV

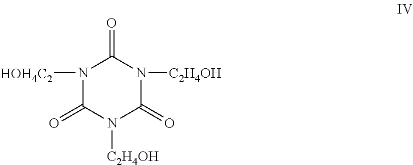

or the reaction products thereof with aromatic carboxylic acids Ar(COOH)ₘ which may optionally be present in a mixture with one another, wherein Ar represents a monocyclic, bicyclic or tricyclic aromatic six-membered ring system and m is 2, 3 or 4.

Examples of suitable carboxylic acids include phthalic acid, isophthalic acid, terephthalic acid, 1,3,5-benzenetricarboxylic acid, 1,2,4-benzenetricarboxylic acid, pyromellitic acid, mellophanic acid, prehnitic acid, 1-naphthoic acid, 2-naphthoic acid, naphthalenedicarboxylic acids, and anthracenecarboxylic acids.

Production is effected by reaction of the tris(hydroxyethyl)isocyanurate with the acids, the alkyl esters thereof or the halides thereof according to the processes in EP-A 584 567.

Such reaction products are a mixture of monomeric and oligomeric esters which may also be crosslinked. The degree of oligomerization is typically 2 to about 100, preferably 2 to 20. Preference is given to using mixtures of THEIC and/or reaction products thereof with phosphorus-containing nitrogen compounds, in particular (NH₄PO₃)ₙ or melamine pyrophosphate or polymeric melamine phosphate. The mixing ratio for example of (NH₄PO₃)ₙ to THEIC is preferably 90.0 to 50.0:10.0 to 50.0, in particular 80.0 to 50.0:50.0 to 20.0, wt % based on the mixture of such compounds.

Also suitable flame retardants are benzoguanidine compounds of formula V

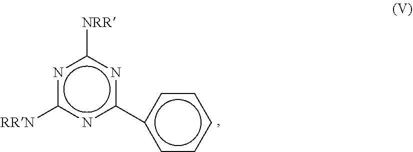

in which R, R′ represents straight-chain or branched alkyl radicals having 1 to 10 carbon atoms, preferably hydrogen, and in particular adducts thereof with phosphoric acid, boric acid and/or pyrophosphoric acid.

Also preferred are allantoin compounds of formula VI,

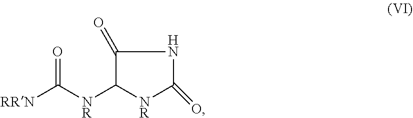

wherein R, R′are as defined in formula V, and also the salts thereof with phosphoric acid, boric acid and/or pyrophosphoric acid and also glycolurils of formula VII or the salts thereof with the abovementioned acids

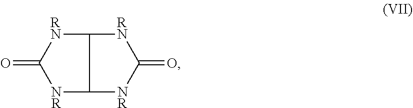

in which R is as defined in formula V.

Suitable products are commercially available or obtainable as per DE-A 196 14 424.

The cyanoguanidine (formula VIII) usable in accordance with the invention is obtainable for example by reacting calcium cyanamide with carbonic acid, the cyanamide produced dimerizing at from pH 9 to pH 10 to afford cyanoguanidine

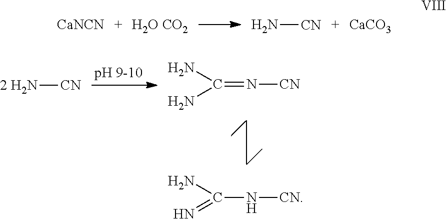

The commercially available product is a white powder having a melting point of 209° C. to 211° C.

It is particularly preferable to employ melamine cyanurate (for example Melapur® MC₂₅ from BASF SE).

It is further possible to employ separate metal oxides such as antimony trioxide, antimony pentoxide, sodium antimonate and similar metal oxides. For a description of pentabromobenzyl acrylate and antimony trioxide or antimony pentoxide reference may be made to EP-A 0 624 626.

It is also possible to employ phosphorus, for example red phosphorus, as component C4₄). Red phosphorus may for example be employed in the form of a masterbatch.

Also contemplated are dicarboxylic acids of formula

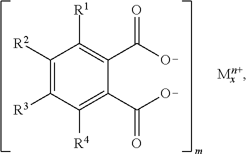

wherein
R¹ to R⁴ independently of one another represent halogen or hydrogen with the proviso that at least one radical R¹ to R⁴ represents halogen,
x=1 to 3, preferably 1, 2
m=1 to 9, preferably 1 to 3, 6, 9, in particular 1 to 3
n=2 to 3
M=alkaline earth metal, Ni, Ce, Fe, In, Ga, Al, Pb, Y, Zn, Hg.

Preferred dicarboxylic acid salts comprise as radicals R¹ to R⁴ independently of one another Cl or bromine or hydrogen, especially preferably all radicals R¹ to R⁴ are Cl or/and Br.

Be, Mg, Ca, Sr, Ba, Al, Zn, Fe are preferred as metals M.

Such dicarboxylic acid salts are commercially available or producible according to the processes described in U.S. Pat. No. 3,354,191.

Also employable as flame-retardant component C4₄) are functional polymers. These may be flame-retardant polymers for example. Such polymers are described in U.S. Pat. No. 8,314,202 for example and comprise 1,2-bis[4-(2-hydroxyethoxy)phenyl]ethanone repeating units. A further suitable functional polymer for increasing the amount of carbon residue is poly(2,6-dimethyl1,4-phenyleneoxide) (PPPO).

As component C4₅) the thermoplastic molding composition can comprise 1 to 30 wt %, preferably 5 to 20, in particular 6 to 10 wt %, of at least one plasticizer.

In the context of the present invention a plasticizer is a compound which is able to decrease the glass transition temperature of the polyamides present in the thermoplastic molding compositions. Suitable plasticizers are known by a person skilled in the art. Examples are lactames, lactones, polyvinylalcoholes, sulfonamides like N-(n-butyl)benzolsulfonamide and derivatives thereof, ethylene glycols like tetraethylene glycol.

As component C4₆) the thermoplastic molding composition can comprise UV stabilizers in amounts of generally up to 2% by weight, based on the amount of the thermoplastic molding composition. Examples for suitable UV stabilizers are various substituted resorcinols, salicylates, benzotriazoles, and benzophenones.

As component C4₇) the thermoplastic molding composition can comprise colorants. Materials that can be added as colorants are inorganic pigments, such as titanium dioxide, ultramarine blue, iron oxide, and carbon black, and also organic pigments, such as phthalocyanines, quinacridones, perylenes, and also dyes, such as anthraquinones.

As component C4₈) the thermoplastic molding composition can comprise nucleating agents. Materials that can be used as nucleating agents are sodium phenylphosphinate, aluminum oxide, silicon dioxide, and also preferably talc.

The polymer blend of the invention can be produced by processes known per se, usually by mixing. The present invention therefore relates to a process for preparing a polymer blend according to the present invention by mixing components A) and B).

The mixing of the starting components A) and B) can be carried out in conventional mixing apparatus known by a person skilled in the art, such as screw-based extruders, especially twin-screw extruders, Brabender mixers, or Banbury mixers. The resulting product may then be extruded. After extrusion, the extrudate can be cooled and pelletized.

Also, the thermoplastic molding compositions of the invention can be produced by processes known per se known by a person skilled in the art, by mixing the starting components A), B) and C) in conventional mixing apparatus, such as screw-based extruders, especially twinscrew extruders, Brabender mixers, or Banbury mixers, and then extruding the same. After extrusion, the extrudate can be cooled and pelletized.

It is also possible to premix individual components, for example components A) and B) to form the polymer blend according to the present invention and then to add the remaining starting materials C) individually and/or likewise in the form of a mixture.

The present invention therefore further relates to a process for preparing a thermoplastic molding composition according to the present invention by mixing components A), B) or the polymer blend according to the present invention with component C).

The mixing temperatures are generally from 230 to 320° C.

The inventive blends and the inventive thermoplastic molding compositions are especially characterized by one or more of the following properties: High stability against zinc chloride and add blue, high heat deflection temperature, high tensile modulus in the dry and the conditioned state high stiffness in the conditioned state, low water uptake, high barrier against fuels. The inventive blends and the inventive thermoplastic molding compositions are highly suitable for injection molding and sheet, foil, tube and pipe extrusion processes and for example processable at mold temperatures which are typical for polyamide processing.

The polymer blends and the thermoplastic molding compositions of the present invention are suitable for the production of moldings of any type, especially for the production of injection molded and blow molded parts and extruded parts (especially pipes and tubes).

Reinforced molding compositions comprising component C1) are especially useful for injection molding. Particularly suitable for injection molding are therefore the preferred reinforced thermoplastic molding compositions TM1.

Unreinforced molding compositions not comprising component C1) are especially useful for extrusion, more preferably sheet, foil, pipe or tube extrusion. Unreinforced thermoplastic molding compositions particularly suitable for extrusion are mentioned above.

Common applications of the inventive blends and thermoplastic molding compositions include automotive, aerospace, electrical, and industrial parts that must withstand prolonged exposure to harsh chemicals and/or high temperatures.

Some specific examples follow: in the field of engineering plastics, especially in the automotive industry, which are in contact with operating fluids like cooling fluid, brake and clutch fluid, chemicals (add blue), fuels and or salt, e.g extruded tubes (e.g. fluid pipes for fuel or cooling fluid in cars, cooling fluids for batteries in electric vehicles), mandrels and injection molded articles like functional parts for engines sensor (e.g. wheel speed sensor), pumps, connectors, or injected or extruded parts of fuels cells.

In the electrical and electronic sector, the inventive blends and thermoplastic molding compositions can be used to produce plugs, plug parts, plug connectors, membrane switches, printed circuit board modules, microelectronic components, coils, I/O plug connectors, plugs for printed circuit boards (PCBs), plugs for flexible printed circuits (FPCs), plugs for flexible integrated circuits (FFCs), high-speed plug connections, terminal strips, connector plugs, device connectors, cable-harness components, circuit mounts, circuit-mount components, three-dimensionally injection-molded circuit mounts, electrical connection elements, and mechatronic components.

Possible uses of the inventive blends and thermoplastic molding compositions in automotive parts and aerospace parts are interiors, e.g. for dashboards, steering-column switches, seat components, headrests, center consoles, gearbox components, and door modules, exteriors e.g. for door handles, exterior-mirror components, windshield-wiper components, windshieldwiper protective housings, grilles, roof rails, sunroof frames, engine covers, cylinder-head covers, intake pipes (in particular intake manifolds), windshield wipers, and also external bodywork components, and motor parts, fuel line connectors, coolant pumps, bushings, bearing pads in aircraft engines, charge air coolers, resonators, engine cover components and heat shields, fuel cutoff and water heater manifold valves, connectors, high voltage bushings, motor housings, and head light components.

Possible uses of the inventive blends and thermoplastic molding compositions in the kitchen and household sector are for the production of components for kitchen devices, e.g. fryers, smoothing irons, knobs, and also applications in the garden and leisure sector, e.g. components for irrigation systems, or garden devices, and door handles.

The present invention therefore further relates to the use of a polymer blend or a thermoplastic molding composition according to the present invention for the production of moldings, especially for the production of extruded parts, injection molded parts and blow molded parts.

The present invention further relates to molded, like injection molded and blow molded, and extruded parts, produced from a polymer blend or from a thermoplastic molding composition according to the present invention. Examples molded and extruded parts are moldings, pipes, like one layer and multilayer pipes, tubes, foils and sheets.

Suitable and preferred uses and molded and extruded parts are mentioned above.

### FIGURES

FIG. 1: storage in add blue

FIG. 1 shows the result of the storage test in add blue. In FIG. 1 the tensile strength at brake after 42 days storage in add blue of examples 1-3 is compared with comparative examples 1 and 2.

Curve 1 Comparative example 1

Curve 2 Example 1

Curve 3 Example 2

Curve 4 Example 3

Curve 5 Comparative example 2

On the abscissa the different time in days is shown.

On the ordinate the tensile strength at break retention against the initial value in [%] is shown.

FIG. 2: Results fuel permeation test

FIG. 2 shows the result of the fuel Permeation test. In FIG. 2 the barrier against fuel of the inventive composition (inventive example 3) and the comparative composition (comparative examples 1 and 2) at 40° C. is shown. As reference/control GF reinforced PA66 (Ultramid® A3WG6 bk564 from BASF SE) and GF reinforced PA6 (Ultramid® B3WG6 bk564 from BASF SE) was tested.

On the abscissa the different compositions are and the different solvents are mentioned:

1 Ultramid® A3WG6 bk564

2 Ultramid® B3WG6 bk564

3 Comparative example 1

4 Example 3

5 Comparative Example 2

A EtOH

B Hydrocarbons

C Total

On the ordinate the permeation in [g/m²*d] is shown (wherein d means “day”).

### EXAMPLES

The following components were used:

### Component A)

AlCoPA 1: PA6/6.36; Ultramid® Flex F29 from BASF SE; (64% Caprolactam, 6.3% HMD, 29,7% C36 partial unsaturated, MT: 199° C.; relative viscosity: 2.8-3.0
AlCoPA2: PA6/6.36 from BASF SE; (64% Caprolactam, 6.3% HMD, 29.7% C36 saturated; Ultramid® Flex F38 from BASF SE) MT:199° C.; relative viscosity: 3.7-3.9
AlCoPA3: PA6/6.36 from BASF SE; (51.5% Caprolactam, 8.5% HMD, 40.0% C36 saturated; from BASF SE) MT:199° C.; relative viscosity: 3.7-3.9

### Component B)

ArPA1: PA 6/6T (30/70) having a viscosity number VZ of 125 ml/g, measured on a 0.5 measured on a 0.5 strength by weight solution in 96% strength by weight of sulfuric acid at 25° C. to ISO 307; MT (melting point) 294° C. (Ultramid® T315 from BASF SE)
ArPA2: PA6T/61 (70:30); ARLEN® 3000 from Mitsui Chemicals Europe GmbH; having a viscosity number VZ of 90 ml/g, measured on a 0.5 measured on a 0.5 strength by weight solution in 96% strength by weight of sulfuric acid at 25° C. to ISO 307, MT. 330° C., Tg: 125° C.
ArPA3: PA6T/66 (70:30): ARLEN® C₂₀₀₀ from Mitsui Chemicals Europe GmbH; having a viscosity number VZ of 100 ml/g, measured on a 0.5 measured on a 0.5 strength by weight solution in 96% strength by weight of sulfuric acid at 25° C. to ISO 307, MT. 310° C., Tg: 125° C.
AmArPA (comparative): amorphous PA61/6T; Zytel® HTN301 from DuPont International Operations Sarl

### Component C)

### GF (Glass Fiber):

DS 1110 having a diameter of 10 μm (DS 1110-10N 4 mm from 3B-FIBREGLASS S.P.R.L)
CMB: 30 w % Carbon Black in LDPE
L1: Lubricant, CALCIUM STEARATE FLAKES; LIGASTAR® CA 600 G from Peter Greven GmbH & Co. KG
L2: Lubricant, ACRAWAX® C BEADS
S1: Stabilizer, Irganox® 1098 ED from BASF SE
S2: Stabilizer, SODIUM HYPOPHOSPHITE MONOHYDRATE from OQEMA GmbH
S3: Stabilizer, OKAFLEX® EM from OKA-Tec Vertriebs GmbH
N1: Nucleating agent: TALKUM I.T. Extra AW from Elementis Minerals B.V.
IM1: Impact Modifier: EXXELOR® VA 1801 from EXXONMOBIL PETROLEUM & CHEMICAL BV
IM2: Impact Modifier: EXXELOR® VA 1803 from EXXONMOBIL PETROLEUM & CHEMICAL BV

### Preparation of the Granules

The polymers shown in tables 1 and 3 were compounded in the quantities specified in tables 1 and 3 in a twin-screw extruder ZSK25 and extruded through a round nozzle with a diameter of 4 mm while preserving granules of the polymer composition. The quantities shown in table 1 are in wt.-%. The temperature profile of the extruder was adjusted to ensure that all polyamides are in the molten state. The temperatures are listed in table 1 which refer to scheme 1 which shows a schematic view of the extruder with the respective segments G1-G11. The polyamides AlCoPA, ArPA, AmArPA and the additives S, CMB and L (see the explanation below) were dosed via the feed zone. The glass fiber was dosed via side feeder in segment G5.

The granulates were proceeded on a standard injection molding machine to specimens by using the in table 1 listed mold and melt temperatures.

Tensile modulus of elasticity, tensile stress at break and tensile strain at break are determined according to ISO 527. The Charpy (notched) impact resistance is determined according to ISO 179-2/1eU and ISO 179-2/1eAf, respectively. Melting point and crystallization temperature are determined according to ISO 11357. All of the norms mentioned above and below refer to the version valid in January 2021.

Scheme 1: Schematic view of the extruder

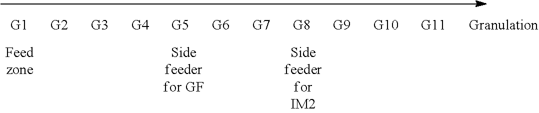

TABLE 1
Preparation and Characterization of GF reinforced compounds based
on aliphatic copolyamides (AlCoPA) and aromatic polyamides (ArPA)

| | | Comparative | | | | Comparative |
|---|---|---|---|---|---|---|
| Raw material | unit | Example 1 | Example 1 | Example 2 | Example 3 | Example 2 |
| AlCoPA1 | w % | 62.43 | 47.43 | 47.43 | 47.43 | 47.43 |
| ArPA1 | w % | | 15.00 | | | |
| ArPA2 | w % | | | 15.00 | | |
| ArPA3 | w % | | | | 15.00 | |
| GF | w % | 35.00 | 35.00 | 35.00 | 35.00 | 35.00 |
| AmArPA | w % | | | | | 15.00 |
| CMB | w % | 1.70 | 1.70 | 1.70 | 1.70 | 1.70 |
| L1 | w % | 0.35 | 0.35 | 0.35 | 0.35 | 0.35 |
| S1 | w % | 0.50 | 0.50 | 0.50 | 0.50 | 0.50 |
| S2 | w % | 0.02 | 0.02 | 0.02 | 0.02 | 0.02 |
| throughput | kg/h | 18 | 18 | 18 | 18 | 18 |
| Temp.-G1 | ° C. | — | — | — | — | — |
| Temp.-G2 | ° C. | 160 | 160 | 160 | 160 | 160 |
| Temp.-G3 | ° C. | 200 | 200 | 200 | 200 | 200 |
| Temp.-G4 | ° C. | 230 | 250 | 250 | 250 | 230 |
| Temp.-G5 | ° C. | 240 | 290 | 300 | 300 | 240 |
| Temp.-G6 | ° C. | 240 | 290 | 330 | 330 | 240 |
| Temp.-G7 | ° C. | 240 | 290 | 330 | 330 | 240 |
| Temp.-G8 | ° C. | 240 | 300 | 330 | 330 | 240 |
| Temp.-G9 | ° C. | 240 | 300 | 330 | 330 | 240 |
| Temp.-G10 | ° C. | 240 | 300 | 330 | 330 | 240 |
| Temp.-G11 | ° C. | 240 | 300 | 330 | 330 | 240 |
| Inject. Mold. | ° C. | 245 | 300 | 300 | 300 | 260 |
| melt temp. | | | | | | |
| Inject. Mold. | ° C. | 80 | 80 | 80 | 80 | 80 |
| mold temp. | | | | | | |

TABLE 2
Properties of GF reinforced blends

| | | | Comparative | | | | Comparative |
|---|---|---|---|---|---|---|---|
| property | norm | unit | Example 1 | Example 1 | Example 2 | Example 3 | Example 2 |
| Humidity | Acc | % | 1.2 | | | 1.2 | 1.5 |
| absorption | ISO62 | | | | | | |
| MVR 275° C./ | ISO 1133 | cm³/10′ | 35 | | | 13 | 35 |
| 5 kg | | | | | | | |
| Tensile modulus | ISO527 | MPa | 8299/5037 | 9075/6466 | 9212/6782 | 9219/6534 | 9019/5994 |
| (dry/cond.) | | | | | | | |
| Stress at break | ISO527 | MPa | 110/73 | 141/98 | 144/103 | 147/102 | 132/97 |
| (dry/cond.) | | | | | | | |
| Strain at break | ISO527 | % | 4.0/7.0 | 4.1/6.5 | 3.9/6.3 | 3.8/6.5 | 5.6/9.2 |
| (dry/cond.) | | | | | | | |
| Charpy unnotched | ISO | kJ/m² | 68/70 | 86/82 | 86/82 | 84/83 | 95/91 |
| impact strength | 179/1eU | | | | | | |
| (23° C.) (dry/cond) | | | | | | | |
| Charpy notched | ISO | kJ/m² | 12/16 | 13/13 | 11/12 | 11/13 | 13/15 |
| impact strength | 179/1eA | | | | | | |
| (23° C.) (dry/cond.) | | | | | | | |
| Charpy notched | ISO | kJ/m² | 8 | 8 | 8 | 8 | 8 |
| impact strength | 179/1eA | | | | | | |
| (−30° C.) (dry) | | | | | | | |
| HDTA | ISO75 | ° C. | 170 | 174 | 171 | 180 | 139 |
| HDTB | ISO75 | ° C. | 187 | 190 | 187 | 193 | 179 |

### Stress Crack Resistance Test

The test fluid is aqueous zinc chloride solution with a concentration of 50 w %. Tensile bars are in dry condition before testing (dry as molded). The tensile bars are clamped on a bending template with 2% edge fiber expansion. Then the surface of the bars is wetted with zinc chloride solution during the tests, images are recorded to determine the time in case of failure. The tests are run until failure or aborted after 3 days if no failure has occurred. As reference/control GF reinforced PA66 (Ultramid® A3EG5 sw564 from BASF SE (Ult. A3EG5 sw564)) and GF reinforced PA6 (Ultramid® B3EG6 sw564 from BASF SE (Ult. B3EG6 s4564)) with comparable tensile modulus was tested.

TABLE 2a
Results zinc chloride stress crack resistance test

| | | Tensile | Time until first |
|---|---|---|---|
| | | modulus | Stress Crack ZnCl2 |
| | | (dry/ | (50%-ig) with 2% |
| Product | Polymer | cond.) | outer fiber strain. |
| Comparative | PA6/6.36-GF35 | 8299/5037 | No cracks |
| Example 1 | | | (abort after 3 days) |
| Example 3 | PA6/6.36 | 9219/6534 | No cracks |
| | Blend-GF35 | | (abort after 3 days) |
| Comparative | PA6/6.36 | 9019/5994 | No cracks |
| Example 2 | Blend-GF35 | | (abort after 3 days) |
| Ult. A3EG5 sw564 | PA66-GF25 | 8600/6500 | 5-10 min |
| Ult. B3EG6 s4564 | PA6-GF30 | 9500/6200 | 5-10 min |

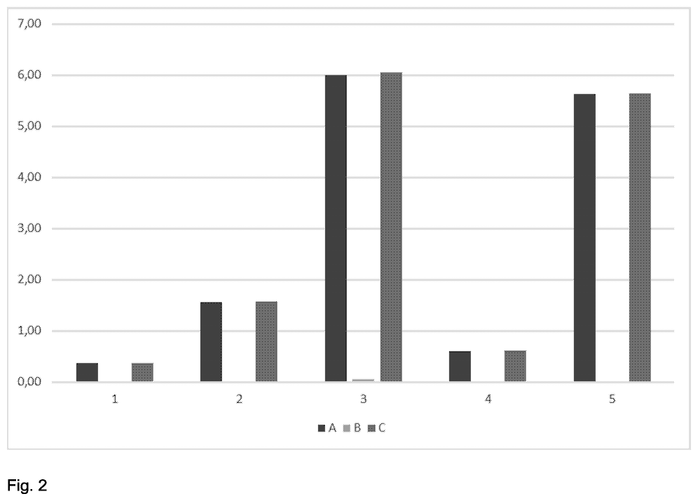

### Fuel Permeation test (FIG. 2)

Work Steps: Injection molding of test specimen (plaques 150×150×1 mm). Accelerated conditioning in specified E10 fuel at 40° C. Migration testing at 40° C. and GC analysis of permeates (2 plaques per sample). As reference/control GF reinforced PA66 (Ultramid® A3WG6 bk564 from BASF SE) and GF reinforced PA6 (Ultramid® B3WG6 bk564 from BASF SE) was tested.

### 2) Preparation and Characterization of Blends of Aliphatic Copolyamide (AlCoPA) Aromatic Polyamide (ArPA)

TABLE 3
blends of aliphatic Copolyamide (AlCoPA)
aromatic polyamide (ArPA)

| | | Comparative | | |
|---|---|---|---|---|
| Raw material | unit | Example 3 | Example 4 | Example 5 |
| AlCoPA1 | w % | 99.03 | 74.03 | 64.03 |
| ArPA1 | w % | | 25.00 | 35.00 |
| L1 | w % | 0.35 | 0.35 | 0.35 |
| S1 | w % | 0.50 | 0.50 | 0.50 |
| S2 | w % | 0.02 | 0.02 | 0.020 |
| N1 | w % | 0.1 | 0.1 | 0.1 |
| throughput | kg/h | 12 | 14 | 14 |
| Temp.-G1 | ° C. | — | — | — |
| Temp.-G2 | ° C. | 140 | 160 | 160 |
| Temp.-G3 | ° C. | 180 | 200 | 200 |
| Temp.-G4 | ° C. | 180 | 250 | 250 |
| Temp.-G5 | ° C. | 190 | 290 | 290 |
| Temp.-G6 | ° C. | 190 | 310 | 310 |
| Temp.-G7 | ° C. | 190 | 310 | 310 |
| Temp.-G8 | ° C. | 190 | 310 | 310 |

*material sticks to the mold

TABLE 4
properties of blends of aliphatic Copolyamide
(AlCoPA) aromatic polyamide (ArPA)

| | | | Compar- | | |
|---|---|---|---|---|---|
| | | | ative | Example | Example |
| property | norm | unit | Example 3 | 4 | 5 |
| Humidity | Acc | % | 1.8 | 2.1 | 2.2 |
| absorption | ISO62 | | | | |
| MVR 275° C./5 kg | ISO | cm³/ | 100 | 92 | 52 |
| | 1133 | 10′ | | | |
| Tensile modulus | ISO527 | MPa | 1541/523 | 1734/862 | 1899/1050 |
| (dry/cond.) | | | | | |
| Stress at yield | ISO527 | MPa | 46/28 | 51/34 | 55/37 |
| (dry/cond.) | | | | | |
| Strain at yield | ISO527 | % | 4.3/23 | 4.1/17 | 4.0/14 |
| (dry/cond.) | | | | | |
| Charpy unnotched | ISO | kJ/m² | no break/ | no break/ | no break/ |
| impact strength | 179/ | | no break | no break | no break |
| (23° C.) (dry/cond) | 1eU | | | | |
| Charpy notched | ISO | kJ/m² | 5.6/ | 5.7/18 | 5.5/14 |
| impact strength | 179/ | | no break | | |
| (23° C.) (dry/cond.) | 1eA | | | | |
| Charpy notched | ISO | kJ/m² | 6 | 4.4 | 4.7 |
| impact strength | 179/ | | | | |
| (−30° C.) (dry) | 1eA | | | | |
| HDTA | ISO75 | ° C. | 41 | 50 | 49 |
| HDTB | ISO75 | ° C. | 46 | 84 | 84 |

### 3) Preparation and Characterization of Impact Modified Compound Based on Aliphatic Copolyamide (AlCoPA) and Aromatic Polyamide (ArPA)

The impact modifier IM1 in comparative example 4 and inventive example 6 was dosed with the other ingredients via the feed zone. In comparative examples 5 and 6 and the inventive examples 7-12 the impact modifier IM2 was dosed via side feeder in segment G. 7-12 the impact modifier IM2 was dosed via side feeder in segment G8.

TABLE 5
Impact modified compounds of aliphatic copolyamide (AlCoPA) aromatic polyamide (ArPA) blends

| | | Compar- | | Compar- | | | | Compar- | | | |
|---|---|---|---|---|---|---|---|---|---|---|---|
| Raw | | ative | | ative | | | | ative | | | |
| material | unit | Exam. 4 | Example 6 | Exam. 5 | Example 7 | Example 8 | Example 9 | Exam. 6 | Example 10 | Example 11 | Example 12 |
| AlCoPA2 | w % | 89.10 | 79.10 | 88.37 | 83.37 | 78.37 | 68.37 | | | | |
| AlCoPA3 | w % | | | | | | | 88.37 | 83.37 | 78.37 | 68.37 |
| ArPA1 | w % | | 10.00 | | | | | | | | |
| ArPA3 | w % | | | 0.00 | 5.00 | 10.00 | 20.00 | 0.00 | 5.00 | 10.00 | 20.00 |
| IM1 | w % | 10.00 | 10.00 | | | | | | | | |
| IM2 | w % | | | 10.00 | 10.00 | 10.00 | 10.00 | 10.00 | 10.00 | 10.00 | 10.00 |
| N1 | w % | 0.05 | 0.05 | 0.05 | 0.05 | 0.05 | 0.05 | 0.05 | 0.05 | 0.05 | 0.05 |
| L1 | w % | 0.40 | 0.40 | 0.40 | 0.40 | 0.40 | 0.40 | 0.40 | 0.40 | 0.40 | 0.40 |
| L2 | w % | 0.20 | 0.20 | 0.20 | 0.20 | 0.20 | 0.20 | 0.20 | 0.20 | 0.20 | 0.20 |
| S1 | w % | 0.25 | 0.25 | | | | | | | | |
| S3 | w % | | | 0.98 | 0.98 | 0.98 | 0.98 | 0.98 | 0.98 | 0.98 | 0.98 |
| Throughput | kg/h | 8 | 10 | 8 | 8 | 8 | 8 | 9 | 8 | 8 | |
| Temp.-G1 | ° C. | — | — | | — | | | | | | |
| Temp.-G2 | ° C. | 160 | 170 | 140 | 140 | 140 | 140 | 130 | 150 | 140 | 140 |
| Temp.-G3 | ° C. | 180 | 200 | 180 | 180 | 180 | 180 | 160 | 180 | 180 | 180 |
| Temp.-G4 | ° C. | 210 | 240 | 230 | 250 | 250 | 250 | 180 | 230 | 250 | 250 |
| Temp.-G5 | ° C. | 240 | 280 | 260 | 300 | 300 | 300 | 210 | 285 | 310 | 310 |
| Temp.-G6 | ° C. | 240 | 290 | 260 | 330 | 330 | 330 | 220 | 325 | 325 | 325 |
| Temp.-G7 | ° C. | 240 | 300 | 270 | 330 | 330 | 330 | 230 | 330 | 330 | 330 |
| Temp.-G8 | ° C. | 240 | 300 | 270 | 335 | 335 | 335 | 230 | 335 | 335 | 335 |
| Temp.-G9 | ° C. | 240 | 300 | 270 | 335 | 335 | 335 | 230 | 335 | 335 | 335 |
| Temp.-G10 | ° C. | 240 | 300 | 270 | 340 | 340 | 340 | 240 | 335 | 340 | 340 |
| Temp.-G11 | ° C. | 250 | 300 | 270 | 340 | 340 | 340 | 240 | 340 | 340 | 340 |
| Inject. Mold. | ° C. | 220 | 280 | | | | | | | | |
| melt temp. | | | | | | | | | | | |
| Inject. Mold. | ° C. | 40 | 40 | | | | | | | | |
| mold temp. | | | | | | | | | | | |

TABLE 6
properties impact modified compounds of aliphatic Copolyamide
(AlCoPA) aromatic polyamide (ArPA) blends

| | | | Comparative | | Comparative | | |
|---|---|---|---|---|---|---|---|
| property | norm | unit | Exam. 4 | Example 6 | Exam. 5 | Example 7 | Example 8 |
| Humidity absorption | Acc ISO62 | % | 1.6 | 1.5 | | | |
| MVR 275° C./5 kg | ISO 1133 | cm³/10′ | 26 | 31 | 29 | 68 | 63 |
| Tensile modulus | ISO527 | MPa | 1186/360 | 1358/545 | 1023/385 | 1094/542 | 1210/570 |
| (dry/cond.) | | | | | | | |
| Stress at yield | ISO527 | MPa | 35/23 | 39/24 | 31/23 | 33/24 | 35/24 |
| (dry/cond.) | | | | | | | |
| Strain at yield | ISO527 | % | 4.3/34 | 4.1/22 | 4.4/26 | 4.5/22 | 4.2/19 |
| (dry/cond.) | | | | | | | |
| Charpy unnotched | ISO 179/1eU | kJ/m² | no break/ | no break/ | 214/ | 192/ | 224/ |
| impact strength | | | no break | no break | | | |
| (23° C.) (dry/cond) | | | | | | | |
| Charpy notched | ISO 179/1eA | kJ/m² | 100/ | 15/ | 84/143 | 10/116 | 11/106 |
| impact strength | | | no break | no break | | | |
| (23° C.) (dry/cond.) | | | | | | | |
| Charpy notched | ISO 179/1eA | kJ/m² | 16 | 16 | 16 | 8 | 9 |
| impact strength | | | | | | | |
| (−30° C.) (dry) | | | | | | | |
| HDTA | ISO75 | ° C. | 40 | 40 | | | |
| HDTB | ISO75 | ° C. | 45 | 57 | | | |

| | | Comparative | | | |
|---|---|---|---|---|---|
| property | Example 9 | Exam. 6 | Example 10 | Example 11 | Example 12 |
| Humidity absorption | | | | | |
| MVR 275° C./5 kg | 33 | 112 | 117 | 193 | 114 |
| Tensile modulus | 1316/559 | 623/365 | 763/512 | 992/566 | 825/583 |
| (dry/cond.) | | | | | |
| Stress at yield | 38/24 | 23/21 | 27/22 | 31/23 | 27/24 |
| (dry/cond.) | | | | | |
| Strain at yield | 4.2/19 | 4.9/24 | 5.2/21 | 4.4/19 | 5.5/18 |
| (dry/cond.) | | | | | |
| Charpy unnotched | 269/ | 197/ | 213/ | 209/ | 206/ |
| impact strength | | | | | |
| (23° C.) (dry/cond) | | | | | |
| Charpy notched | 14/118 | 105/139 | 9/34 | 7/19 | 7/16 |
| impact strength | | | | | |
| (23° C.) (dry/cond.) | | | | | |
| Charpy notched | 10 | 17 | 6 | 4 | 5 |
| impact strength | | | | | |
| (−30° C.) (dry) | | | | | |
| HDTA | | | | | |
| HDTB | | | | | |

| | Comparative | Example |
|---|---|---|
| | Exam. 4 | 6 |
| Screw speed 1/min | 18 | 22 |
| Current uptake % | 40-45% | 40-50% |
| Melt temperature ° C. | 220 | 213 |

### Reinforced Thermoplastic Molding Compositions

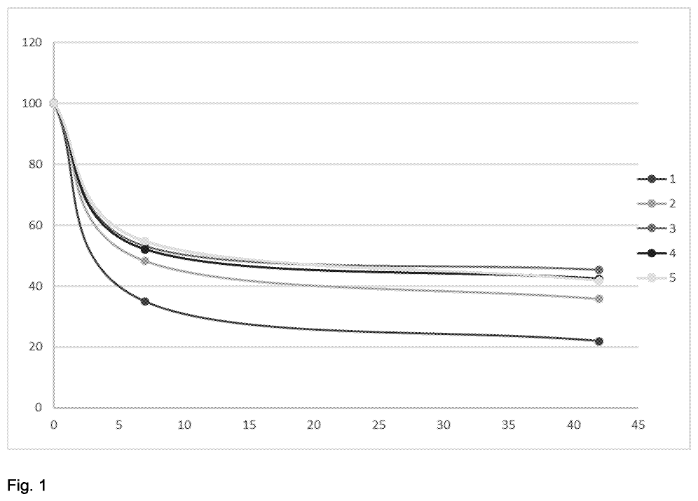

In table 1 the preparation of glass fiber reinforced compounds is described. The stiffness (tensile modulus and tensile strength) in the conditioned state is significantly increased (examples 1-3), while stability against zinc chloride (stress crack resistance) is still high (see tabel 3). Surprisingly compositions comprising blends of aliphatic copolyamides with semicrystalline, semiaromatic polyamides according to the present invention show an increased barrier against fuel which the pure aliphatic copolyamides (comparative example 1) and compositions comprising blends of aliphatic copolyamides and amorphous, semiaromatic polyamides (comparative example 2) do not show (see FIG. 2). The examples 1-3 and comparative example 2 have a higher tensile strength at brake after 42 days storage in add blue compared to the comparative example 1 (FIG. 1). Furthermore, the blend of aliphatic copolyamide and polyamide 6T/66 (example 3) additionally shows increased heat deflection temperatures (HDTA and HDTB). If an amorphous semiaromatic polyamide is used (comparative example 2) the heat deflection temperature is even decreased (see table 2). Although the melting temperature of the semicrystalline, semiaromatic polyamides in Examples 2 and 3 is above 300° C., the resulting compounds could be processed in injection molding with a maximum melt temperature of 300° C.

In summary, reinforced thermoplastic compositions based on the inventive blends, with high stability against zinc chloride, add blue, high heat deflection temperature, high stiffness in the conditioned state, low water uptake, high barrier against fuels which could be processed in injection molding with melt temperatures below 300° could be obtained. This property profile offers a wide range of applications in the field of engineering plastics as mentioned above.

In the first heating curve of the DSC curve of example 3 the separate melting point of the aliphatic copolyamide (AlCoPA) at 195.4° C. and the melting point of the semicrystalline, semiaromatic polyamide (ArPA3) at 308.77° C. can be observed. Surprisingly no significant transamination has occurred during compounding. In the 2^{nd} heating curve after the sample was hold for 5 minutes in the molten state, a new melting peak at 174.95° C. occured which belongs to a transamidation product derived from the aliphatic copolyamide (AlCoPA) and the semicrystalline, semiaromatic polyamide (ArPA3). Due to this observation it is possible to carry out a targeted control of the material properties in the injection molding step.

In table 4 the preparation of inventive polymer blends (example 4 and example 5) of an aliphatic copolyamide (AlCoPA) and a semicrystalline, semiaromatic polyamide (ArPA) are described. The blends were processed via injection molding and compared with the comparative example 3 which does not contain the semicrystalline, semiaromatic polyamide. The comparative example 3 was hardly processable in injection molding since the material sticks to the mold surface. As a consequence it was necessary to work with very low mold temperature (40° C.). In contrast, inventive examples 4 and 5 were processable with higher mold temperatures (80° C.) which are typical for polyamide processing. Inventive examples 4 and 5 have higher tensile modulus in the dry and the condition state and the heat deflection temperatures (HDTA and HDTB) are significantly increased compared to comparative example 3.

### I. Impact Modified Thermoplastic Molding Compositions

In table 5 the preparation of impact modified thermoplastic molding compositions in one compounding step is described. The comparative examples 4 and 5 showed problems during the granulation process. The granules stacked together und it was hardly possible to cut the granules. Inventive example 6 shows an increased tensile modulus in the conditioned state and an increased HDTB value compared to the comparative example 5. Comparative example 4 and inventive example 6 were extruded to 12 mm pipes. Inventive example 6 could be extruded below the melt temperature of the semicrystalline, semiaromatic polyamide ArPA1 at 210° C. The pipes made from inventive example 6 had a smooth opaque surface while it was difficult to produce pipes from comparative example 4. The material stacked to the nozzle and it was not possible to produce pipes with a smooth surface.

1. A hydroxyl-functional thioether compound having formula (I) 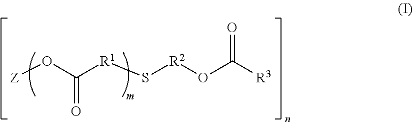
wherein
Z is an n-valent hydrocarbyl group, optionally comprising one or more moieties selected from the group consisting of an ether moiety, a thioether moiety and an isocyanurate moiety:
R¹ is a linear or branched alkylene group:
R² is selected from the group consisting of CH₂CH(OH)CH₂ and CH(CH₂OH)CH₂;
R³ is a linear or branched alkyl group:
m=0 or 1; and
n=2 to 10.

2. The hydroxyl-functional thioether compound according to claim 1, wherein
the n-valent hydrocarbyl group Z contains 2 to 16 carbon atoms; and/or
the linear or branched alkylene group R¹ contains 1 to 6 carbon atoms; and/or
the linear or branched alkyl group R³ contains 1 to 16 carbon atoms; and/or
n=2 to 8.

3. The hydroxyl-functional thioether compound according to claim 1, wherein
the n-valent hydrocarbyl group Z contains 2 to 10 carbon atoms; and/or
the linear or branched alkylene group R¹ contains 1 to 3 carbon atoms: and/or
the linear or branched alkyl group R³ contains 1 to 10 carbon atoms.

4. The hydroxyl-functional thioether compound according to claim 1, wherein
the n-valent hydrocarbyl group Z contains 2 to 10 carbon atoms; and/or
R² is CH₂CH(OH)CH₂; and/or
the linear or branched alkyl group R³ contains 1 to 9 carbon atoms; and/or
n=2 to 6.

5. The hydroxyl-functional thioether compound according to claim 1, wherein
Z is an n-valent hydrocarbyl group or an n-valent hydrocarbyl group comprising one or more ether moieties; and
m=1

6. The hydroxyl-functional thioether compound according to claim 1, wherein
Z is an n-valent hydrocarbyl group comprising one or more thioether moieties: and m=0.

7. A method of producing a hydroxyl-functional thioether according to claim 1, wherein
(a) one or more species Z—[O(C═O)R¹)ₘ—SH]ₙ are reacted with
(b) one or more species of formula (II) 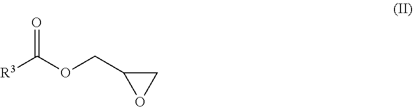
and
(c) that in case of m=1 the one or more species Z—[O(C═O)R¹)ₘ—SH]ₙ are obtainable obtained by reacting one or more species Z[OH]ₙ with n species of HOOC—R¹—SH.

8. A thermally curable composition, comprising
(A) one or more hydroxyl-functional thioethers according to claim 1; and
(B) one or more crosslinking agents, which are reactive with the hydroxyl groups of the one or more hydroxyl-functional thioethers (A).

9. The thermally curable composition according to claim 8, wherein at least one of the crosslinking agents is selected from the group of free diisocyanates, blocked diisocyanates, free polyisocyanates, blocked polyisocyanates, and aminoplast resins.

10. The thermally curable composition according to claim 8, further comprising (C) one or more polymeric polyols.

11. The thermally curable composition according to claim 8, wherein the composition is selected from the group consisting of a coating composition, an adhesive composition, and a sealant composition.

12. A method of using the hydroxyl-functional thioether according to claim 1, wherein the method comprising using the hydroxyl-functional thioether as a reactive diluent in thermally curable compositions.

13. A multilayer coating comprising at least two coating layers, wherein at least one of the layers is formed from the thermally curable composition according to claim 8.

14. A multilayer coated substrate, wherein the substrate is coated with a multilayer coating according to claim 13.

15. A method of producing the multilayer coating on a substrate, the method comprising the steps of:
(i) applying at least one basecoat composition on a substrate to form a basecoat layer and subsequently,
(ii) applying at least one topcoat composition, onto the basecoat composition to form a topcoat layer, followed by
(iii) curing of the fully cured coating layers at a temperature in a range from 20° C. to 200° C.,
wherein at least one basecoat composition or at least one topcoat composition is the thermally curable composition according to claim 8.
